(19) United States
(12) Patent Application Publication
(10) Pub. No.: US 2021/0136363 A1
(43) Pub. Date: May 6, 2021

(54) INTER-PREDICTION METHOD FOR TEMPORAL MOTION INFORMATION PREDICTION IN SUB-BLOCK UNIT, AND DEVICE THEREFOR

(71) Applicant: LG ELECTRONICS INC., Seoul (KR)

(72) Inventor: Hyeongmoon JANG, Seoul (KR)

(21) Appl. No.: 17/149,217

(22) Filed: Jan. 14, 2021

Related U.S. Application Data
(63) Continuation of application No. PCT/KR2019/008760, filed on Jul. 16, 2019.
(60) Provisional application No. 62/698,885, filed on Jul. 16, 2018.

(51) Int. Cl. H04N 19/107; H04N 19/176; H04N 19/18; H04N 19/124; H04N 19/105

(52) U.S. Cl. CPC H04N 19/107; H04N 19/176; H04N 19/105; H04N 19/124; H04N 19/18

(57) ABSTRACT

An image decoding method performed by a decoding apparatus according to the present disclosure includes deriving a temporal motion information candidate of a sub-block unit for a current block by determining whether the temporal motion information candidate of the sub-block unit can be derived based on the size of the current block, constructing a motion information candidate list for the current block based on the temporal motion information candidate of the sub-block unit, and generating prediction samples of the current block by deriving motion information of the current block based on the motion information candidate list, wherein the temporal motion information candidate of the sub-block unit for the current block is derived based on motion vectors of a sub-block unit of a corresponding block located correspondingly to the current block in a reference picture, and the corresponding block is derived in the reference picture based on a motion vector of a spatial neighboring block of the current block.

### CROSS-REFERENCE TO RELATED APPLICATIONS

Pursuant to 35 U.S.C. § 119(e), this application is a continuation of International Application PCT/KR2019/008760, with an international filing date of Jul. 16, 2019, which claims the benefit of U.S. Provisional Patent Application No. 62/698,885, filed on Jul. 16, 2018, the contents of which are hereby incorporated by reference herein in its entirety.

### TECHNICAL FIELD

The present disclosure relates to an image coding technology, and more particularly, to an inter prediction method and apparatus for predicting temporal motion information of a sub-block unit in an image coding system.

### BACKGROUND

The demands for high-resolution and high-quality images and video, such as an ultra high definition (UHD) image and video of 4K or 8K or more, are recently increasing in various fields. As image and video data become high resolution and high quality, the amount of information or the number of bits that is relatively transmitted is increased compared to the existing image and video data. Accordingly, if image data is transmitted using a medium, such as the existing wired or wireless wideband line, or image and video data are stored using the existing storage medium, transmission costs and storage costs are increased.

Furthermore, interests and demands for immersive media, such as virtual reality (VR), artificial reality (AR) content or a hologram, are recently increasing. The broadcasting of an image and video having image characteristics different from those of real images, such as game images, is increasing.

Accordingly, there is a need for a high-efficiency image and video compression technology in order to effectively compress and transmit or store and playback information of high-resolution and high-quality images and video having such various characteristics.

### SUMMARY

A technical objective of the present disclosure is to provide a method and apparatus which increase image coding efficiency.

Another technical objective of the present disclosure is to provide an efficient inter prediction method and apparatus.

Still another technical objective of the present disclosure is to provide a method and apparatus which improve prediction performance by deriving a sub-block-based temporal motion vector.

Still another technical problem of the present disclosure is to provide a method and apparatus which are capable of reducing a loss of compression performance in comparison to improvement of hardware complexity by adjusting a sub-block size in deriving a sub-block-based temporal motion vector.

According to an example of the present disclosure, there is provided an image decoding method which is performed by a decoding apparatus. The method includes deriving a temporal motion information candidate of a sub-block unit for a current block by determining based on the size of the current block whether a temporal motion information candidate of a sub-block unit can be derived, constructing a motion information candidate list for the current block based on the temporal motion information candidate of a sub-block unit, and generating prediction samples of the current block by deriving motion information of the current block based on the motion information candidate list, wherein the temporal motion information candidate of a sub-block unit for the current block is derived based on motion vectors of a sub-block unit of a corresponding block located correspondingly to the current block in a reference picture, and the corresponding block is derived in the reference picture based on a motion vector of a spatial neighboring block of the current block.

According to another example of the disclosure, an image encoding method which is performed by an encoding apparatus is provided. The method includes deriving a temporal motion information candidate of a sub-block unit for a current block by determining based on the size of the current block whether a temporal motion information candidate of a sub-block unit can be derived, constructing a motion information candidate list for the current block based on the temporal motion information candidate of a sub-block unit, generating prediction samples of the current block by deriving motion information of the current block based on the motion information candidate list, deriving residual samples based on prediction samples of the current block, and encoding information on the residual samples, wherein the temporal motion information candidate of a sub-block unit for the current block is derived based on motion vectors of a sub-block unit of a corresponding block located correspondingly to the current block in a reference picture, and the corresponding block is derived in the reference picture based on a motion vector of a spatial neighboring block of the current block.

According to the present disclosure, it is possible to increase overall image/video compression efficiency.

According to the present disclosure, it is possible to increase the efficiency of image coding based on inter prediction, and to reduce the amount of data required to transmit a residual signal through efficient inter prediction.

According to the present disclosure, performance and efficiency of inter prediction can be improved by efficiently deriving temporal motion vector information of a sub-block unit according to the current block size.

### BRIEF DESCRIPTION OF THE DRAWINGS

FIG. 1 schematically represents an example of a video/image coding system to which the present disclosure may be applied.

FIG. 2 is a diagram schematically describing a configuration of a video/image encoding apparatus to which the present disclosure may be applied.

FIG. 3 is a diagram schematically describing a configuration of a video/image decoding apparatus to which the present disclosure may be applied.

FIG. 4 is a flowchart schematically illustrating an inter prediction method.

FIG. 5 is a flowchart schematically illustrating a method of constructing a motion information candidate in inter prediction, and FIG. 6 illustratively represents a spatial neighboring block and a temporal neighboring block of a current block used to construct a motion information candidate.

FIG. 7 illustratively represents a spatial neighboring block that can be used to derive a temporal motion information candidate (ATMVP candidate) in inter prediction.

FIG. 8 is a diagram schematically illustrating a method of deriving a sub-block-based temporal motion information candidate (ATMVP candidate) in inter prediction.

FIG. 9 is a diagram schematically illustrating a method for deriving a sub-block-based temporal motion candidate (ATMVP-ext candidate) in inter prediction.

FIG. 10 is a flowchart schematically illustrating an inter prediction method according to an example of the present disclosure.

FIG. 11 and FIG. 12 are diagrams for explaining a process of deriving a motion vector on a current block unit basis from a corresponding block of a reference picture, and FIG. 13 is a diagram for describing a process of deriving a motion vector on a sub-block unit basis of a current block from a corresponding block of a reference picture.

FIG. 14 is a diagram for explaining an example in which a restricted area is applied when inducing an ATMVP candidate.

FIG. 15 is a flowchart schematically illustrating an image encoding method by an encoding apparatus according to the present disclosure.

FIG. 16 is a flowchart schematically illustrating an image decoding method by a decoding apparatus according to the present disclosure.

FIG. 17 illustratively represents a content streaming system structure diagram to which the present disclosure is applied.

### DESCRIPTION OF EXEMPLARY EMBODIMENTS

This document may be modified in various ways and may have various embodiments, and specific embodiments will be illustrated in the drawings and described in detail. However, this does not intend to limit this document to the specific embodiments. Terms commonly used in this specification are used to describe a specific embodiment and is not used to limit the technical spirit of this document. An expression of the singular number includes plural expressions unless evidently expressed otherwise in the context. A term, such as “include” or “have” in this specification, should be understood to indicate the existence of a characteristic, number, step, operation, element, part, or a combination of them described in the specification and not to exclude the existence or the possibility of the addition of one or more other characteristics, numbers, steps, operations, elements, parts or a combination of them.

Meanwhile, elements in the drawings described in this document are independently illustrated for convenience of description related to different characteristic functions. This does not mean that each of the elements is implemented as separate hardware or separate software. For example, at least two of elements may be combined to form a single element, or a single element may be divided into a plurality of elements. An embodiment in which elements are combined and/or separated is also included in the scope of rights of this document unless it deviates from the essence of this document.

Hereinafter, preferred embodiments of this document are described more specifically with reference to the accompanying drawings. Hereinafter, in the drawings, the same reference numeral is used in the same element, and a redundant description of the same element may be omitted.

This document relates to video/image coding. For example, the method/example disclosed in this document may relate to Versatile Video Coding (VVC) standard (ITU-T Rec. H.266), the next-generation video/image coding standard after VVC, or other video coding related standards (e.g., High Efficiency Video Coding (HEVC) standard (ITU-T Rec. H.265), Essential Video Coding (EVC) standard, AVS2 standard, etc.).

In this document, a variety of embodiments relating to video/image coding may be provided, and, unless specified to the contrary, the embodiments may be performed in combination with each other.

In this document, a video may mean a set of a series of images over time. A picture generally means a unit representing an image in a specific time zone, and a slice/tile is a unit constituting a part of the picture in coding. The slice/tile may include one or more coding tree units (CTUs). One picture may be constructed of one or more slices/tiles. One picture may be constructed of one or more tile groups. One tile group may include one or more tiles.

A pixel or a pel may mean a minimum unit constituting a single picture (or image). Further, a term ‘sample’ may be used as a term corresponding to the term pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information associated with the region. One unit may include one luma block and two chroma (e.g., cb, cr) blocks. The term ‘unit’ may be used interchangeably with a term, such as block or area, in some cases. In a general case, an M×N block may include samples (or a sample array) or a set (or an array) of transform coefficients consisting of M columns and N rows.

In this document, the term “/“and”,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

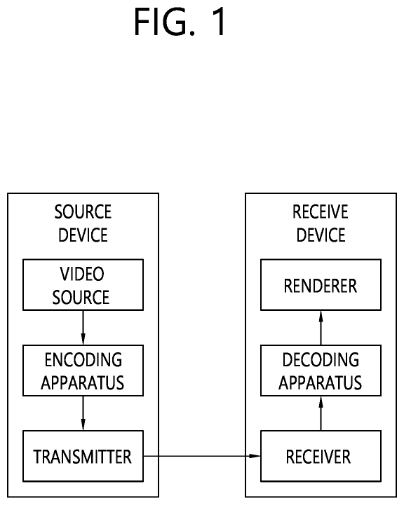

FIG. 1 schematically illustrates an example of a video/image coding system to which embodiments of this document may be applied.

Referring to FIG. 1, a video/image coding system may include a source device and a receiving device. The source device may deliver encoded video/image information or data in the form of a file or streaming to the receiving device via a digital storage medium or network.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compression and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

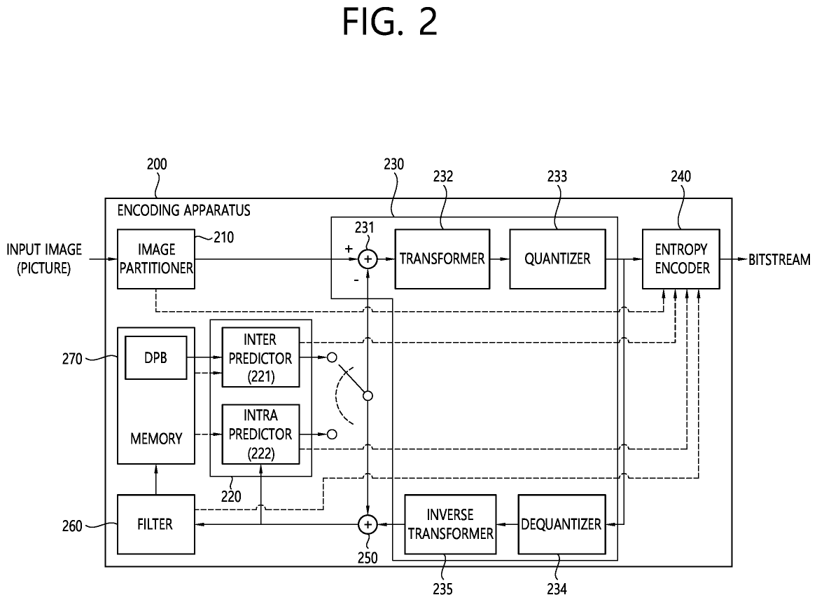

FIG. 2 is a schematic diagram illustrating a configuration of a video/image encoding apparatus to which the embodiment(s) of the present document may be applied. Hereinafter, the video encoding apparatus may include an image encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to this document may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

The subtractor 231 may subtract the prediction signal (predicted block, prediction samples, or prediction sample array) output from the predictor 220 from the input image signal (original block, original samples, or original sample array) to generate a residual signal (residual block, residual sample array), and the generated residual signal is transmitted to the transformer 232. The predictor 220 may perform prediction on a processing target block (hereinafter, referred to as a ‘current block’), and may generate a predicted block including predicted samples for the current block. The predictor 220 may determine whether intra prediction or inter prediction is applied in a current block or CU unit. As discussed later in the description of each prediction mode, the predictor may generate various information relating to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, B1 prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods to be described below. For example, for prediction on one block, the predictor may apply either intra prediction or inter prediction, and, as well, apply both of intra prediction and inter prediction at the same time. The latter may be called combined inter and intra prediction (CIIP). In addition, the predictor may perform intra block copy (IBC) for prediction on a block. The intra block copy may be used for content image/video coding of a game or the like, such as screen content coding (SCC). The IBC basically performs prediction in a current block, but it may be performed similarly to inter prediction in that it derives a reference block in a current block. That is, the IBC may use at least one of inter prediction techniques described in the present document.

The prediction signal generated through the inter predictor 221 and/or the intra predictor 222 may be used to generate a reconstructed signal or to generate a residual signal. The transformer 232 may generate transform coefficients by applying a transform technique to the residual signal. For example, the transform technique may include a discrete cosine transform (DCT), a discrete sine transform (DST), a graph-based transform (GBT), or a conditionally non-linear transform (CNT). Here, the GBT means transform obtained from a graph when relationship information between pixels is represented by the graph. The CNT means transform obtained based on a prediction signal generated using all previously reconstructed pixels. In addition, the transform process may be applied to square pixel blocks having the same size or may be applied to non-square blocks having variable sizes.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. Signaled/transmitted information and/or syntax elements described later in this document may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the predictor 220 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus may be avoided and encoding efficiency may be improved.

The DPB of the memory 270 may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

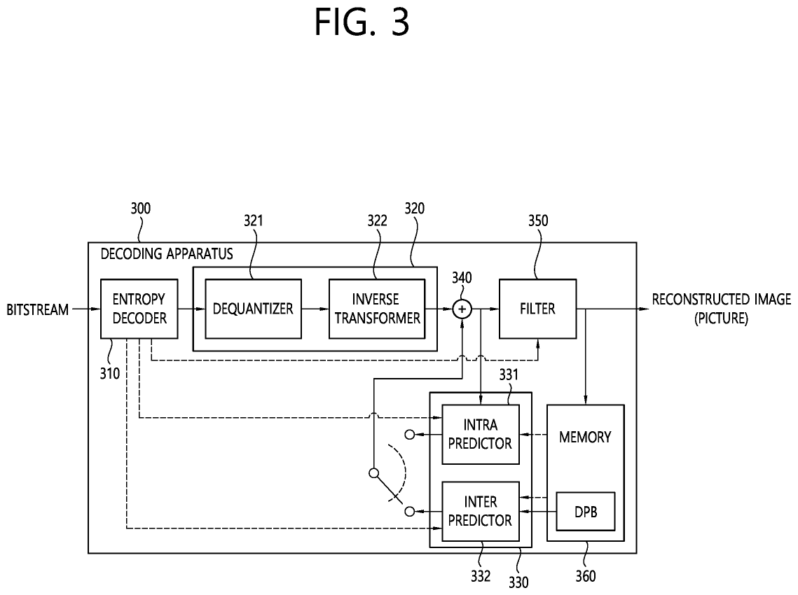

FIG. 3 is a schematic diagram illustrating a configuration of a video/image decoding apparatus to which the embodiment(s) of the present document may be applied.

Referring to FIG. 3, the decoding apparatus 300 may include an entropy decoder 310, a residual processor 320, a predictor 330, an adder 340, a filter 350, a memory 360. The predictor 330 may include an inter predictor 331 and an intra predictor 332. The residual processor 320 may include a dequantizer 321 and an inverse transformer 321. The entropy decoder 310, the residual processor 320, the predictor 330, the adder 340, and the filter 350 may be configured by a hardware component (ex. a decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in this document may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor 330, and information on the residual on which the entropy decoding was performed in the entropy decoder 310, that is, the quantized transform coefficients and related parameter information, may be input to the dequantizer 321. In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to this document may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the predictor 330, the adder 340, the filter 350, the memory 360.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor 330 may perform prediction on the current block and generate a predicted block including prediction samples for the current block. The predictor 330 may determine whether intra prediction or inter prediction is applied to the current block based on the information on the prediction output from the entropy decoder 310 and may determine a specific intra/inter prediction mode.

The predictor 330 may generate a prediction signal based on various prediction methods to be described below. For example, for prediction on one block, the predictor 330 may apply either intra prediction or inter prediction, and, as well, apply both of intra prediction and inter prediction at the same time. The latter may be called combined inter and intra prediction (CIIP). In addition, the predictor 330 may perform intra block copy (IBC) for prediction on a block. The intra block copy may be used for content image/video coding of a game or the like, such as screen content coding (SCC). The IBC basically performs prediction in a current block, but it may be performed similarly to inter prediction in that it derives a reference block in a current block. That is, the IBC may use at least one of inter prediction techniques described in the present document.

The intra predictor 332 may predict the current block by referring to the samples in the current picture. The referenced samples may be located in the neighborhood of the current block or may be located apart according to the prediction mode. In intra prediction, prediction modes may include a plurality of non-directional modes and a plurality of directional modes. The intra predictor 332 may determine the prediction mode applied to the current block by using the prediction mode applied to the neighboring block.

The inter predictor 331 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, B1 prediction, etc.) information. In the case of inter prediction, the neighboring block may include a spatial neighboring block present in the current picture and a temporal neighboring block present in the reference picture. For example, the inter predictor 331 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor 330. If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 331. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 332.

In this specification, the examples described in the predictor 330, the dequantizer 321, the inverse transformer 322, the filter 350 and the like of the decoding apparatus 300 may be similarly or correspondingly applied to the predictor 220, the dequantizer 234, the inverse transformer 235, the filter 260 and the like of the encoding apparatus 200, respectively.

Meanwhile, as described above, the prediction is performed in order to increase compression efficiency in performing video coding. Through this, a predicted block including prediction samples for a current block, which is a coding target block, may be generated. Here, the predicted block includes prediction samples in a space domain (or pixel domain). The predicted block may be derived indentically in the encoding apparatus and the decoding apparatus, and the encoding apparatus may signal to the decoding apparatus not an original sample value of an original block itself but information on residual (residual information) between the original block and the predicted block, by which it is possible to increase the image coding efficiency. The decoding apparatus may derive a residual block including residual samples based on the residual information, generate a reconstructed block including reconstruction samples by adding the residual block and the predicted block, and generate a reconstructed picture including reconstructed blocks.

The residual information may be generated through transform and quantization procedures. For example, the encoding apparatus may derive a residual block between the original block and the predicted block, derive transform coefficients by performing a transform procedure on residual samples (residual sample array) included in the residual block, and derive quantized transform coefficients by performing a quantization procedure on the transform coefficients, so that it may signal associated residual information to the decoding apparatus (through a bitstream). Here, the residual information may include value information, position information, a transform technique, transform kernel, a quantization parameter or the like of the quantized transform coefficients. The decoding apparatus may perform a dequantization/inverse transform procedure and derive the residual samples (or residual block), based on residual information. The decoding apparatus may generate a reconstructed picture based on the predicted block and the residual block. The encoding apparatus may also derive a residual block by dequantizing/inverse transforming quantized transform coefficients for reference for inter prediction of a next picture, and may generate a reconstructed picture based on this.

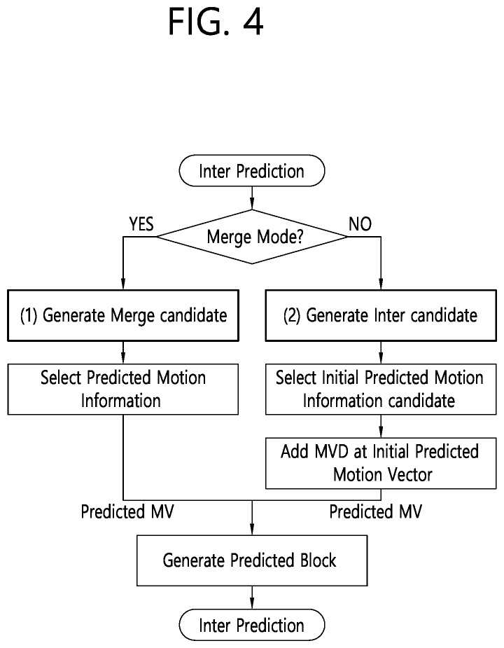

FIG. 4 is a flowchart schematically illustrating an inter prediction method.

Referring to FIG. 4, the inter prediction method, which is a technology for generating predicted motion information (PMI), may be classified into a merge mode and an inter mode including a motion vector prediction (MVP) mode. At this time, in the inter prediction modes such as the merge mode and the inter mode, a motion information candidate (e.g., merge candidate, MVP candidate, etc.) is derived to generate a prediction block by inducing a final PMI, and a candidate to be used as the final PMI is selected from among the derived motion information candidates, and information on the selected candidate (e.g., merge index, mvp index, mvp flag, etc.) is signaled. Further, reference picture information, a motion vector difference (MVD), and the like may be additionally signaled. Here, whether to additionally signal the reference picture information, the motion information difference, and the like may distinguish between the merge mode, the inter mode and the like.

For example, the merge mode is a method in which inter prediction is performed by signaling a merge index indicating a candidate to be used as a final PMI among merge candidates. That is, the merge mode may generate predicted samples (prediction blocks) of the current block by using motion information of the merge candidate indicated by the merge index among the merge candidates. Therefore, the merge mode does not require additional syntax information other than the merge index to derive the final PMI.

The inter mode is an inter prediction method in which a final PMI is derived by additionally signaling the motion information difference (MVD) along with an mvp flag (mvp index) indicating a candidate to be used as a final PMI among MVP candidates. That is, in the inter mode, the final PMI is derived based on the motion vector of the MVP candidate indicated by the mvp flag (mvp index) among the MVP candidates and the motion information difference (MVD), and predicted samples (prediction block) of the current block may be generated using the final PMI.

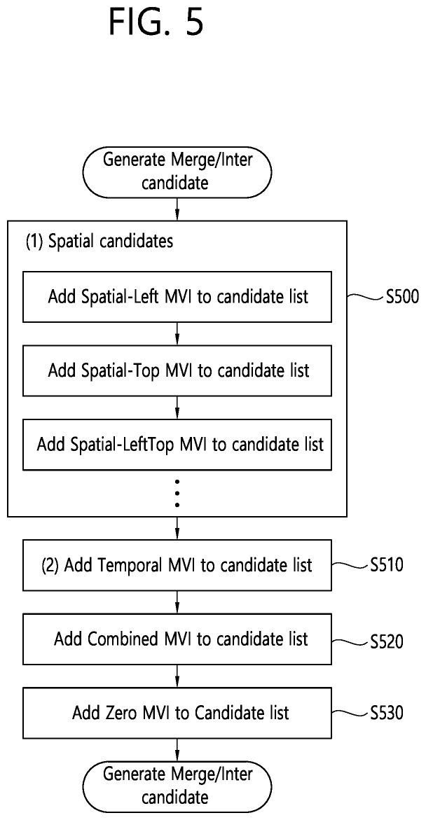

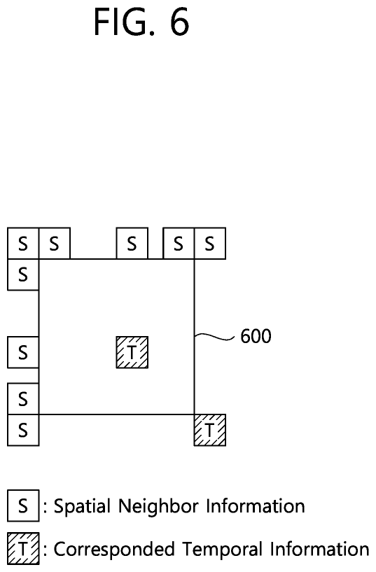

FIG. 5 is a flowchart schematically illustrating a method of constructing a motion information candidate in inter prediction, and FIG. 6 illustratively represents a spatial neighboring block and a temporal neighboring block of a current block used to construct a motion information candidate.

Referring to FIG. 5, the encoding apparatus/decoding apparatus may derive a spatial motion information candidate based on a spatial neighboring block of a current block (S500).

The spatial neighboring block refers to neighboring blocks located around the current block 600, which is a target for performing inter prediction, as shown in FIG. 6, and may include neighboring blocks located around the left side of the current block 600 or neighboring blocks located around the upper side of the current block 600. For example, the spatial neighboring block may include a bottom-left corner neighboring block, a left neighboring block, a top-right corner neighboring block, a top neighboring block, a top-left corner neighboring block of the current block 600. In FIG. 6, the spatial neighboring blocks are shown as “S”.

In one embodiment, the encoding apparatus/decoding apparatus may detect available neighboring blocks by searching spatial neighboring blocks (a bottom-left corner neighboring block, a left neighboring block, a top-right corner neighboring block, a top neighboring block, a top-left corner neighboring block) of the current block in a predetermined order, and may derive motion information of detected neighboring blocks as the spatial motion information candidate.

The encoding apparatus/decoding apparatus may derive a temporal motion information candidate based on a temporal neighboring block of a current block (S510).

The temporal neighboring block is a block located on a picture different from the current picture including the current block (i.e., a reference picture), and refers to a block (collocated block) at the same position as the current block within the reference picture. Here, the reference picture may be before or after the current picture on a picture order count (POC). Also, a reference picture used when deriving a temporal neighboring block may be referred to as a collocated picture. In addition, a collocated block may represent a block located at a position in a col picture corresponding to a position of a current block, and may be referred to as a col block. For example, as shown in FIG. 6, the temporal neighboring block may include a bottom-right corner neighboring block of a col block and/or a center bottom-right block of a col block located correspondingly to the current block 600 within a reference picture (i.e., a col picture). In FIG. 6, the temporal neighboring blocks are shown as “T”.

In one embodiment, the encoding apparatus/decoding apparatus may detect an available neighboring block by searching a temporal neighboring block (e.g., a bottom-right corner neighboring block of a col block, a center bottom-right block of a col block) of the current block in a predetermined order, and may derive motion information of the detected block as the temporal motion information candidate. The technique using the temporal neighboring block like this may be referred to as temporal motion vector prediction (TMVP).

The encoding apparatus/decoding apparatus may construct a motion information candidate list based on the current candidates (spatial motion information candidate and temporal motion information candidate) derived above.

In this case, the encoding apparatus/decoding apparatus may compare the number of current candidates (spatial motion information candidates and/or temporal motion information candidates) derived above with the maximum candidate number required to construct a motion information candidate list, and may add a combined bi-predictive candidate and a zero vector candidate to the motion information candidate list when the number of current candidates is smaller than the maximum candidate number according to the comparison result (S520, S530). The maximum candidate number may be predefined, or may be signaled from the encoding apparatus to the decoding apparatus.

As described above, when constructing the motion information candidate in the inter prediction, the spatial motion information candidate derived based on spatial similarity and the temporal motion information candidate derived based on temporal similarity are used. However, the TMVP method, in which the motion information candidate is derived using the temporal neighboring block, uses the motion information of the col block within the reference picture corresponding to a bottom-right corner sample position of the current block or a center bottom-right sample position of the current block, and thus may not reflect motion within the screen. Accordingly, as a method for improving the conventional TMVP method, adaptive temporal motion vector prediction (ATMVP) may be used. As a method of correcting temporal similarity information considering spatial similarity, the ATMVP is a method in which a col block is derived based on a position indicated by a motion vector of a spatial neighboring block, and the motion vector of the derived col block is used as a temporal motion information candidate (i.e., an ATMVP candidate). As described above, by deriving the col block using the spatial neighboring block, the ATMVP can increase the accuracy of the col block when compared with the conventional TMVP method.

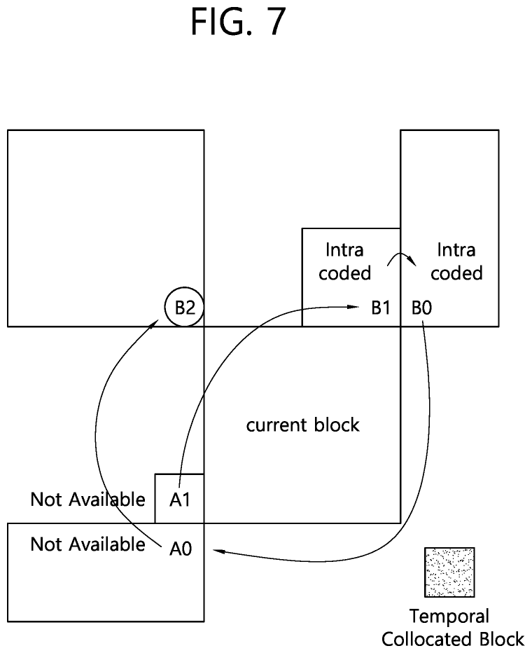

FIG. 7 illustratively represents a spatial neighboring block that can be used to derive a temporal motion information candidate (ATMVP candidate) in inter prediction.

As described above, the inter prediction method applying ATMVP (hereinafter, referred to as an ATMVP mode) can construct the temporal motion information candidate (i.e., ATMVP candidate) by using the spatial neighboring block of the current block to derive the col block (or corresponding block).

Referring to FIG. 7, in the ATMVP mode, the spatial neighboring block may include at least one of a bottom-left corner neighboring block A0, a left neighboring block A1, a top-right corner neighboring block B0, a top neighboring block B1, and a top-left corner neighboring block B2 of the current block. In some cases, the spatial neighboring block may further include a neighboring block other than the neighboring blocks shown in FIG. 7, or may not include a specific neighboring block among the neighboring blocks shown in FIG. 7. Also, the spatial neighboring block may include only a specific neighboring block, and for example, may include only the left neighboring block A1 of the current block.

When constructing the temporal motion information candidate while applying the ATMVP mode, the encoding apparatus/decoding apparatus may detect the motion vector (temporal vector) of the spatial neighboring block which is first available while searching the spatial neighboring blocks according to a predetermined search order, and may determine a block at a position indicated by the motion vector (temporal vector) of the spatial neighboring block in the reference picture as the col block (i.e., corresponding block).

In this case, the availability of the spatial neighboring block may be determined based on reference picture information, prediction mode information, position information, and the like of the spatial neighboring block. For example, when the reference picture of the spatial neighboring block and the reference picture of the current block are the same, the corresponding spatial neighboring block may be determined to be available. Alternatively, when the spatial neighboring block is coded in the intra prediction mode or the spatial neighboring block is located outside the current picture/tile, it may be determined that the corresponding spatial neighboring block is not available.

In addition, the spatial neighboring block search order may be variously defined, and may be, for example, A1, B1, B0, A0, and B2. Alternatively, it may be determined whether or not A1 is available by searching only A1.

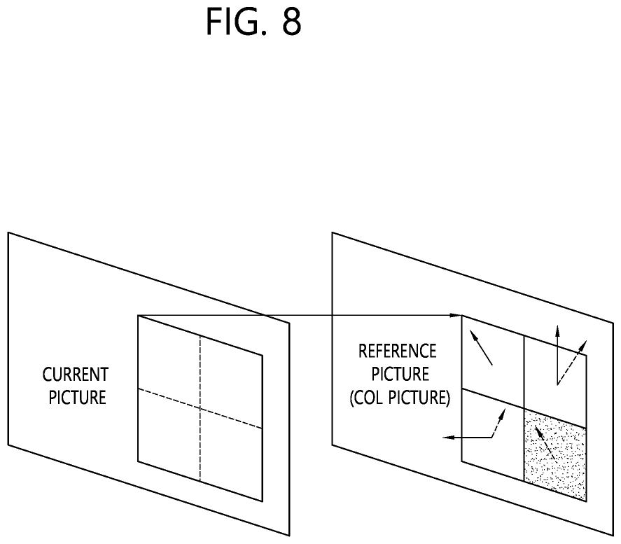

FIG. 8 is a diagram schematically illustrating a method of deriving a sub-block-based temporal motion information candidate (ATMVP candidate) in inter prediction.

The ATMVP mode may derive a temporal motion information candidate for the current block on a sub-block unit basis. In this case, the temporal motion information candidate (ATMVP candidate) may be constructed by dividing the current block into sub-blocks and deriving motion vectors of a corresponding block for each sub-block. In this case, since the ATMVP candidate is derived based on the motion vectors of a sub-block unit, it may also be referred to as a sub-block-based ATMVP (sbTMVP: sub-block-based temporal motion vector prediction) candidate.

Referring to FIG. 8, as described above, the encoding apparatus/decoding apparatus may specify a corresponding block located correspondingly to the current block in the reference picture based on the spatial neighboring block of the current block. In addition, the encoding apparatus/decoding apparatus may derive the motion vectors of a sub-block unit for the corresponding block, and use them as motion vectors (i.e., ATMVP candidate) of a sub-block unit for the current block. In this case, by applying scaling to the motion vectors of a sub-block unit of the corresponding block, the motion vectors of a sub-block unit of the current block may be derived. The scaling may be performed based on a temporal distance difference between the reference picture of the corresponding block and a reference picture of the current block.

In deriving the motion vectors of a sub-block unit for the corresponding block, there may be a case where no motion vectors exist in a specific sub-block within the corresponding block. In this case, for the specific sub-block in which no motion vectors exist, a motion vector of a block located at the center of the corresponding block may be used, and stored as a representative motion vector. Here, the block located at the center of the corresponding block may refer to a block including a center bottom-right sample of the corresponding block. The center bottom-right sample of the corresponding block may refer to a sample among four samples, which is located at the center of the corresponding block.

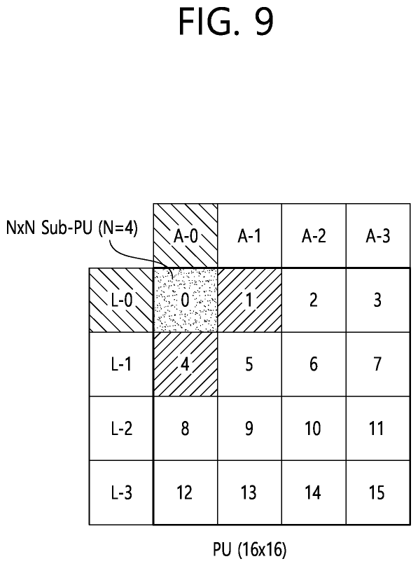

FIG. 9 is a diagram schematically illustrating a method for deriving a sub-block-based temporal motion candidate (ATMVP-ext candidate) in inter prediction.

Similarly to the ATMVP method, the ATMVP-ext mode is a method for improving the conventional TMVP, and is implemented by extending the ATMVP. The ATMVP-ext mode can construct the temporal motion information candidate (i.e., ATMVP-ext candidate) by deriving the motion vector on a sub-block unit basis based on two spatial neighboring blocks and two temporal neighboring blocks for the current block.

Referring to FIG. 9, the current block may be divided into sub-blocks 0 to 15. Here, the motion vector for the sub-block (0) of the current block may be derived by detecting motion vectors of an available block among the temporal neighboring blocks corresponding to the spatial neighboring block (L-0, A-0) and sub-block (1, 4) positions, and calculating the average of these motion vectors. In this regard, when only some of four blocks (that is, two spatial neighboring blocks and two temporal neighboring blocks) are available, the average value of the motion vectors of the available blocks may be calculated, and used as a motion vector for the sub-block (0) of the current block. Here, the reference picture index may be used while being fixed to 0. Other sub-blocks 1 to 15 within the current block may also derive a motion vector through the same process as the sub-block 0.

The temporal motion information candidate derived using the ATMVP or the ATMVP-ext as described above may be included in the motion information candidate list (e.g., merge candidate list, MVP candidate list, sub-block merge candidate list). For example, when constructing the motion information candidate list in a case of applying the merge mode, the merge candidates may be applied by increasing the number thereof in order to use the ATMVP scheme. At this time, it may be applied without using any additional syntax. When using the ATMVP candidate, the maximum number of the merge candidates included in the sequence parameter set (SPS) may be changed from previous five to six. For example, in the conventional merge mode, the availability of merge candidates was checked in the order of {A1, B1, B0, A0, B2, Combined bi-pred, Zero vector} to add five available merge candidates sequentially to a merge candidate list. Here, A1, B1, B0, A0, and B2 may be of representing spatial neighboring blocks as shown in FIG. 7. When using the ATMVP scheme in the merge mode, the availability of merge candidates may be checked in the order of {A1, B1, B0, A0, ATMVP, B2, Combined bi-pred, Zero vector} to add six available merge candidates sequentially to a merge candidate list. In addition, similarly to the ATMVP scheme, when the ATMVP-ext scheme is used in the merge mode, a specific syntax for supporting the corresponding mode may not be added, and a motion information candidate list may be constructed by increasing the number of merge candidates. For example, when using both the ATMVP candidate and the ATMVP-ext candidate, the maximum number of merge candidates may be set to 7, and at this time, the availability check of the merge candidate list may be performed in the order of {A1, B1, B0, A0, ATMVP, ATMVP-Ext, B2, Combined bi-pred, Zero vector}.

Hereinafter, a method of performing inter prediction by applying the ATMVP or ATMVP-ext scheme on a sub-block unit basis will be described in detail.

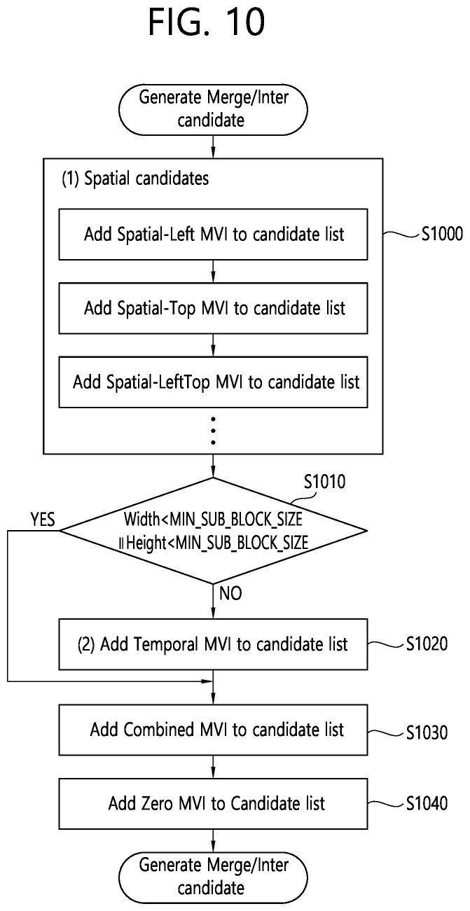

FIG. 10 is a flowchart schematically illustrating an inter prediction method according to an example of the present disclosure. The method of FIG. 10 may be performed by the encoding apparatus 200 of FIG. 2 and the decoding apparatus 300 of FIG. 3.

The encoding apparatus/decoding apparatus may generate prediction samples (prediction blocks) by applying the inter prediction mode such as the merge mode and the MVP (or AMVP) mode to the current block. For example, when the merge mode is applied, the encoding apparatus/decoding apparatus may construct a merge candidate list by deriving a merge candidate. Alternatively, when the MVP (or AMVP) mode is applied, the encoding apparatus/decoding apparatus may construct an MVP (or AMVP) candidate list by deriving an MVP (or AMVP) candidate. In this case, when constructing a motion information candidate list (e.g., a merge candidate list, an MVP candidate list, etc.), motion information of a sub-block unit may be derived and used as a motion information candidate. This will be described in detail with reference to FIG. 10.

Referring to FIG. 10, the encoding apparatus/decoding apparatus may derive a spatial motion information candidate based on a spatial neighboring block of a current block and add it to a motion information candidate list (S1000). This process may be performed in the same manner as step S500 of FIG. 5, and since it has been described with reference to FIGS. 5 and 6, a detailed description will be omitted.

The encoding apparatus/decoding apparatus may determine whether the temporal motion information candidate of a sub-block unit can be derived based on the size of the current block (S1010).

As an example, the encoding apparatus/decoding apparatus may determine whether the temporal motion information candidate of a sub-block unit can be derived for the current block according to whether the size of the current block is smaller than the minimum sub-block size (MIN_SUB_BLOCK_SIZE).

Here, the minimum sub-block size may be predetermined, and for example, may be predefined as an 8×8 size. However, the 8×8 size is only an example, and may be defined as a different size under the consideration of hardware performance or coding efficiency of the encoder/decoder. For example, the minimum sub-block size may be 8×8 or more, or may be also set as a size smaller than 8×8. In addition, information on the minimum sub-block size may be signaled from the encoding apparatus to the decoding apparatus.

When the size of the current block is larger than the minimum sub-block size, the encoding apparatus/decoding apparatus may determine that a temporal motion information candidate of a sub-block unit can be derived for the current block, derives temporal motion information candidates of a sub-block unit for the current block, and add it to a motion information candidate list (S1020).

In an example, when the minimum sub-block size is predefined as 8×8 size and the size of the current block is larger than 8×8 size, the encoding apparatus/decoding apparatus divides the current block into sub-blocks of a fixed size, derive a temporal motion information candidate of a sub-block unit for the current block based on motion vectors of the sub-blocks within the corresponding block corresponding to the sub-blocks within the current block.

Here, the temporal motion information candidate of a sub-block unit for the current block may be derived based on motion vectors of a sub-block unit of a corresponding block (or col block) located correspondingly to the current block in the reference picture (or col picture). The corresponding block may be derived in the reference picture based on the motion vector of the spatial neighboring block of the current block. For example, the position of the corresponding block in the reference picture may be specified by the top-left sample of the corresponding block, and the top-left sample position of the corresponding block may correspond to a position moved by the motion vector of the spatial neighboring block from the top-left sample position of the current block on the reference picture. In addition, the size (width/height) of the corresponding block may be the same as the size (width/height) of the current block.

The spatial neighboring block may be derived by checking availability based on neighboring blocks including at least one of a bottom-left corner neighboring block, a left neighboring block, a top-right corner neighboring block, a top neighboring block, and a top-left corner neighboring block of the current block. Since this has been described in detail with reference to FIG. 7, detailed descriptions thereof will be omitted.

In deriving the temporal motion information candidate of a sub-block unit for the current block, the encoding apparatus/decoding apparatus applies the above-described ATMVP or ATMVP-ext scheme to derive an ATMVP candidate or an ATMVP-ext candidate (hereinafter, referred to as an sbTMVP candidate for convenience of description) of a sub-block unit, and may add this candidate to the motion information candidate list. Since the process of deriving the sbTMVP candidate has been described in detail with reference to FIGS. 8 and 9, a specific description thereof will be omitted.

As a result of determination in step S1010, if the size of the current block is smaller than the minimum sub-block size, then the encoding apparatus/decoding apparatus may determine that the temporal motion information candidate of a sub-block unit cannot be derived for the current block, and may not perform a process of deriving the temporal motion information candidate of a sub-block unit for the current block.

In an example, when the minimum sub-block size is predefined as an 8×8 size and the current block size is any one of 4×4, 4×8, or 8×4, the encoding apparatus/decoding apparatus may determine that the size of the current block is smaller than the minimum sub-block size, and may not derive the temporal motion information candidate of a sub-block unit for the current block.

The encoding apparatus/decoding apparatus may compare the number of current candidates (spatial motion information candidates and temporal motion information candidates) derived above with the maximum candidate number required to construct a motion information candidate list, and may add a combined bi-predictive candidate and a zero vector candidate to the motion information candidate list when the number of current candidates is smaller than the maximum candidate number according to the comparison result (S1030, S1040). The maximum candidate number may be predefined, or may be signaled from the encoding apparatus to the decoding apparatus.

Meanwhile, the process of deriving a temporal motion information candidate of a sub-block unit for the current block requires a process of fetching motion vectors of a sub-block unit from a corresponding block on a reference picture. The reference picture in which the corresponding block is located is a picture that has already been coded (encoded/decoded), and is stored in a memory (i.e., DPB). Accordingly, in order to obtain the motion information from the reference picture stored in a memory (i.e., DPB), a process of accessing the memory and fetching the corresponding information is required.

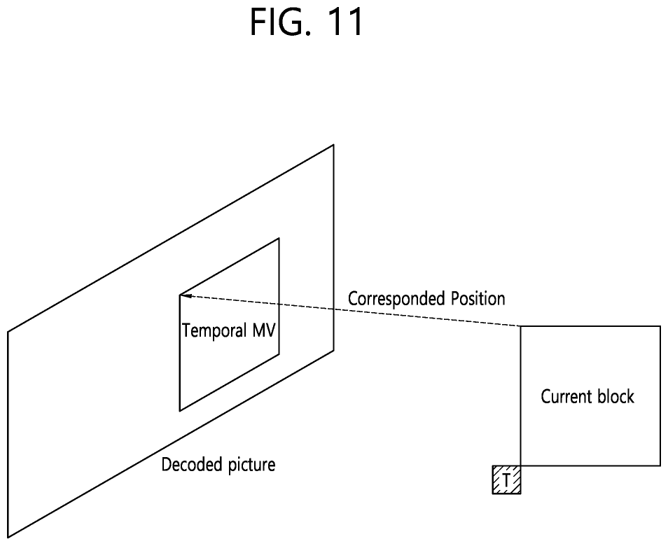

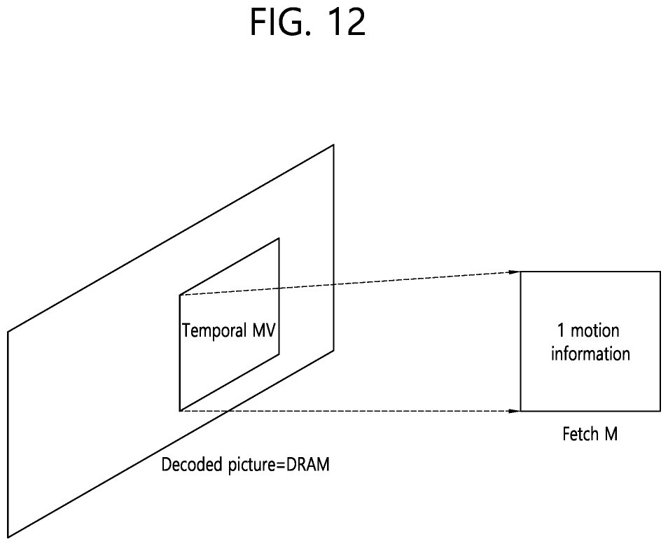

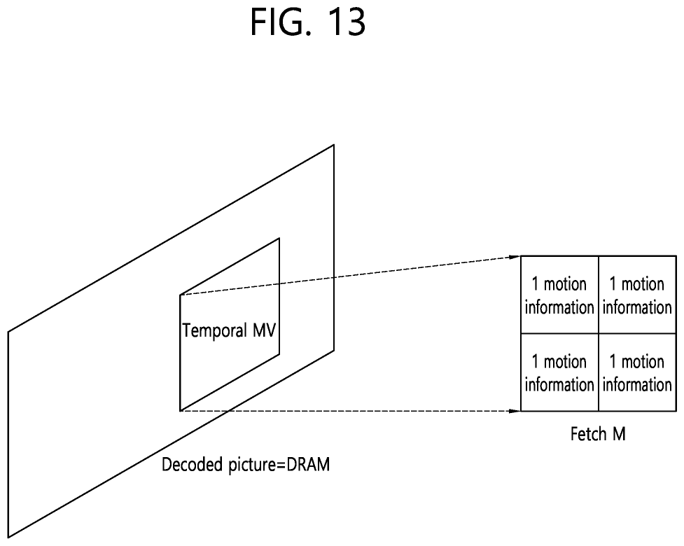

FIG. 11 and FIG. 12 are diagrams for explaining a process of deriving a motion vector on a current block unit basis from a corresponding block of a reference picture, and FIG. 13 is a diagram for describing a process of deriving a motion vector on a sub-block unit basis of a current block from a corresponding block of a reference picture.

Referring to FIGS. 11 and 12, in order to derive the temporal motion information candidate for the current block, the corresponding block located correspondingly to the current block may be derived from the reference picture. At this time, since the reference picture has already been coded (encoded/decoded) and stored in the memory (i.e., DPB), a process of accessing the memory and fetching the motion vector (temporal motion vector) from the corresponding block on the reference picture must be performed. The temporal motion information candidate (i.e., temporal motion vector) for the current block may be derived through such memory fetch.

However, as described above, the temporal motion vector may be derived on a current block unit basis, but the temporal motion vector may be derived on a sub-block unit basis for the current block. This is a method in which the temporal motion vector is derived on a sub-block unit basis by applying the above-described ATMVP or ATMVP-ext scheme, and in this case, a larger amount of data must be fetched from the memory.

FIG. 13 shows a case where the current block is divided into 4 sub-blocks. Referring to FIG. 13, in order to derive a temporal motion information candidate of a sub-block unit for the current block, motion vectors from the corresponding block of the reference picture to four sub-blocks within the current block must be fetched from the memory. In this case, when compared with the process of deriving the temporal motion vector on a current block unit basis shown in FIGS. 11 and 12, it can be understood that more memory fetching processes are required according to the number of sub-blocks. That is, the size of the sub-block may affect the process of fetching data from memory, which may affect the encoder/decoder pipeline configuration and throughput according to the hardware fetch performance. When the sub-block is excessively divided within the current block, a problem in which fetching must be performed several times may occur depending on the size of the memory bus that performs the fetch. Accordingly, the present disclosure proposes a method which can use a sub-block, adjusting its size to prevent excessive fetching processes from occurring.

Meanwhile, in the conventional ATMVP or ATMVP-ext, the temporal motion vector is derived by dividing the current block into sub-block units of 4×4 size. In this case, since the fetch process is performed on a sub-block unit basis of 4×4 size, there is a problem in that excessive memory access occurs and hardware complexity increases.

Accordingly, in the present disclosure, by determining a fixed minimum sub-block size, and causing the current block to perform fetch with the fixed minimum sub-block size, the loss of compression performance in comparison to hardware complexity improvement can be reduced. As an example, the fixed minimum sub-block size may be determined as 8×8, 16×16, or 32×32 size. Experimental results revealed that this fixed minimum sub-block size leads to small loss of compression performance in comparison to the improvement of hardware complexity.

Table 1 below shows the compression performance obtained by performing ATMVP after dividing into sub-block units of the conventional 4×4 size.

Table 2 below shows the compression performance of a method obtained by performing ATMVP after dividing into sub-block units of an 8×8 size according to an example of the present disclosure.

Table 3 below shows the compression performance of a method obtained by performing ATMVP after dividing into sub-block units of a 16×16 size according to an example of the present disclosure.

Table 4 below shows the compression performance of a method obtained by performing ATMVP after dividing into sub-block units of a 32×32 size according to an example of the present disclosure.

As shown in Tables 1 to 4, it can be found based on the experimental results that the difference between compression efficiency and decoding speed has a trade-off result according to the sub-block size.

The sub-block size used to derive the ATMVP candidate as described above may be predefined, or may be information signaled from the encoding apparatus to the decoding apparatus. Hereinafter, a method of signaling a sub-block size according to an example of the present disclosure will be described.

In an example of the present disclosure, information on the sub-block size may be signaled at a slice level or a sequence level. For example, the default sub-block size used in the process of deriving an ATMVP candidate may be signaled at the sequence level, and additionally, one flag information may be signaled at the picture/slice level to indicate whether the default sub-block size is used in the current slice. In this case, when the flag information is false (that is, when indicating that the default sub-block size is not used in the current slice), the sub-block size may be additionally signaled in the slice header for the picture/slice.

Table 5 shows an example of a syntax table signaling information on an ATMVP mode (i.e., ATMVP candidate derivation process) and information on a sub-block size in a sequence parameter set. Table 6 shows an example of a semantics table that defines information represented by the syntax elements of Table 5 above.

TABLE 5

| sequence_parameter_set( ) { | Descriptor |
|---|---|
| ...... | |
| sps_atmvp_enabled_flag | u(l) |
| if(sps_atmvp_enabled_flag) | |
| log2_atmvp_sub_block_size_default_minus2 | ue(v) |
| ...... | |
| } | |

TABLE 6
sps_atmvp_enabled_flag equal to 1 specifies the ATMVP is enabled. sps_atmvp_enabled_flag
equal to 0 specifies the ATMVP is disabled.
1og2_atmvp_sub_block_size_default_ minus2 plus 2 specifies the inferred value of
log2_atmvp_sub_block_size_active_minus2 for the slices with
atmvp_sub_block_size_override_flag is equal to 0.

Table 7 shows an example of a syntax table signaling information on a sub-block size in a slice header. Table 8 shows an example of a semantics table that defines information represented by the syntax elements of Table 7 above.

TABLE 7

| slice_segment_header( ) { | Descriptor |
|---|---|
| ...... | |
| if(sps_atmvp_enabled_flag) | |
| atmvp_sub_block_size_override_flag | ue(v) |
| if(atmvp_sub_block_size_override_flag) | |
| log2_atmvp_sub_block_size_active_minus2 | ue(v) |
| ...... | |
| } | |

TABLE 8
atmvp_sub_block_size_override_flag equal to 1 specifics that the syntax
log2_atmvp_sub_block_size_active_minus2 is present for the current slice.
atmvp_sub_block_size_override_flag equal to 0 specifies that the syntax element
log2_atmvp_sub_block_size_active_minus2 is not present,
log2_atmvp_sub_block_size_active_minus2 is inferred to be equal to
log2_atmvp_sub_block_size_default_minus2.
log2_atmvp_sub_block_size_active_minus2 plus 2 specifies the value of the sub-block size that
is used for deriving the motion parameters for the ATMVP of the current slice.

As shown in Tables 5 to 8 above, a flag (sps_atmvp_enabled_flag) indicating whether an ATMVP mode (i.e., ATMVP candidate derivation process) is applied in the sequence parameter set may be signaled. In addition, when the ATMVP mode (i.e., ATMVP candidate derivation process) is applied, information on the sub-block size used in the ATMVP candidate derivation process (log 2_atmvp_sub_block_size_default_minus2) may be signaled. At this time, depending on whether the sub-block size for deriving the ATMVP candidate is used at the slice level, information on the sub-block size (atmvp_sub_block_size_override_flag, log 2_atmvp_sub_block_size_active_minus2) may be signaled in the slice header.

Table 9 shows an example of a syntax table signaling information on a sub-block size in a sequence parameter set. Table 10 shows an example of a semantics table that defines information represented by the syntax elements of Table 9 above.

TABLE 9

| sequence_parameter_set( ) { | Descriptor |
|---|---|
| ...... | |
| log2_atmvp_sub_block_size_default_minus2 | ue(v) |
| ...... | |
| } | |

TABLE 10
log2_atmvp_sub_block_size_default_minus2 plus 2 specifies the inferred
value of
log2_atmvp_sub_block_size_active_minus2 for the slices with
atmvp_sub_block_size_override_flag is equal to 0.

Table 11 shows an example of a syntax table signaling information on a sub-block size in a slice header. Table 12 shows an example of a semantics table that defines information represented by the syntax elements of Table 11 above.

TABLE 11

| slice_segment_header( ) { | Descriptor |
|---|---|
| ...... | |
| atmvp_sub_block_size_override_flag | ue(v) |
| if(atmvp_sub_block_size_override_flag) | |
| log2_atmvp_sub_block_size_active_minus2 | ue(v) |
| ...... | |
| } | |

TABLE 12
atmvp_sub_block_size_override_flag equal 1 specifies that the syntax
log2_atmvp_sub_block_size_active_minus2 is present for the current slice.
atmvp_sub_block_size_override_flag equal to 0 specifies that the syntax element
log2_atmvp_sub_block_size_active_minus2 is not present,
log2_atmvp_sub_block_size_active_minus2 is inferred to be equal to
log2_atmvp_sub_block_size_default_minus2.
log2_atmvp_sub_block_size_active_minus2 plus 2 specifies the value of the sub-block size that
is used for deriving the motion parameters for the ATMVP of the current slice. The variable is
derived to subBlkLog2Width and subBlkLog2Height is derived to be equal to
log2_atmvp_sub_block_size_default_minus2 plus 2. log2_atmvp_sub_block_size_active_minus2
shall be in the range of 0 to 1.

As shown in Tables 9 to 12 above, information (log 2_atmvp_sub_block_size_default_minus2) on the sub-block size used in the process of deriving the ATMVP candidate in the sequence parameter set may be signaled. At this time, depending on whether the sub-block size for deriving the ATMVP candidate is used at the slice level, information on the sub-block size (atmvp_sub_block_size_override_flag, log 2_atmvp_sub_block_size_active_minus2) may be signaled in the slice header.

Table 13 shows an example of a syntax table signaling information on a sub-block size in a sequence parameter set. Table 14 shows an example of a semantics table that defines information represented by the syntax elements of Table 13 above.

TABLE 13

| sequence_parameter_set( ) { | Descriptor |
|---|---|
| ...... | |
| log2_atmvp_sub_block_size_default_minus2 | ue(v) |
| ...... | |
| } | |

TABLE 14
log2_atmvp_sub_block_size_default_minus2 plus 2 specifies the value of the subblock size that
is used for deriving the motion parameters for the ATMVP.
When log2_atmvp_sub_block_size_active_minus2 is not present, it is inferred to be equal to 0 for
the slices.

Table 15 shows an example of a syntax table signaling information on a sub-block size in a slice header. Table 16 shows an example of a semantics table that defines information represented by the syntax elements of Table 15 above.

TABLE 15

| slice_segment_header( ) { | Descriptor |
|---|---|
| ...... | |
| atmvp_sub_block_size_inherit_flag | ue(v) |
| ...... | |
| } | |

TABLE 16
atmvp_sub_block_size_inherit_flag equal to 0 specifies that the variable subBlkLog2Width and
subBlkLog2Height is derived to be equal to log2_atmvp_sub_block_size_default_minus2 plus 2.
atmvp_sub_block_size_inheirt_flag equal to 1 specifies that the variable subBlkLog2Width and
subBlkLog2Height is derived to be (!log2_atmvp_sub_block_size_default_minus2) plus 2.

As shown in Tables 13 to 16 above, information (log 2_atmvp_sub_block_size_default_minus2) on the sub-block size used in the process of deriving the ATMVP candidate in the sequence parameter set may be signaled. In this case, additional information (atmvp_sub_block_size_inherit_flag) on whether to use information on the sub-block size (log 2_atmvp_sub_block_size_default_minus2) may be signaled in the slice header.

Meanwhile, as described above, a corresponding block used to derive a temporal motion information candidate (i.e., ATMVP candidate) of a sub-block unit for the current block is located in a reference picture (i.e., col picture), and the reference picture may be derived from a reference picture list. The reference picture list may be constructed of a reference picture list 0 (L0) and a reference picture list 1 (L1). The reference picture list 0 is used in a P slice coded by unidirectional inter prediction using one reference picture, or in a B slice coded by forward, backward or bidirectional inter prediction using two reference pictures. The reference picture list 1 can be used in the B slice. As the reference picture list is constructed of L0 and L1, the process of finding a corresponding block for each of the reference picture lists L0 and L1 is repeated. Further, since the corresponding block is specified in the reference picture based on the spatial neighboring block of the current block, the process of searching a spatial neighboring block of the current block may also be performed for each of the reference picture lists L0 and L1. Accordingly, the present disclosure proposes a method capable of simplifying an iterative process of checking the reference picture lists L0 and L1.

In an example of the present disclosure, flag information (collocated_from_10_flag) indicating from which of the reference picture lists L0 and L1 the reference picture (i.e., col picture) used to derive the ATMVP candidate is derived may be used. By referring to only one of the reference picture lists L0 and L1 according to the flag information (collocated_from_10_flag), the corresponding block within the reference picture is specified, and the motion vector of the corresponding block can be used as an ATMVP candidate.

Further, when the motion vector of the spatial neighboring block available first while searching the spatial neighboring blocks of the current block in a predetermined order is detected, an ATMVP candidate can be determined, based on the motion vector of the spatial neighboring block detected as being first available, by specifying a corresponding block in a reference picture and deriving a motion vector of a sub-block unit of the corresponding block. Thereafter, the availability check process for the remaining spatial neighboring blocks may be skipped. In an example, the search order for checking availability of spatial neighboring blocks may be A0, B0, B1, and A1, but this is only an example. Alternatively, it is also possible to check whether only A1 is available in order to simplify the process of checking the availability of spatial neighboring blocks. Here, the spatial neighboring blocks A0, B0, A1, B1, and B2 represent those shown in FIG. 7.

The above-described example of the present disclosure may be implemented according to the spec shown in Table 17 below.

```
TABLE 17
    1. Decoding process for advanced temporal motion vector prediction mode
Inputs to this process are:
  - a luma location ( xCb, yCb ) specifying the top-left luma sample of the current coding block relative to the
top-left luma sample of the current picture.
  - a variable nCbW specifying the width of the current luma prediction block,
  - a variable nCbH specifying the width of the current luma prediction block,
  - the availability flags availableFlagA0, availableFlagA1, availableFlagB0 and availableFlagB1,
  - the prediction list utilization flags predFlagLXA0, predFlagLXA1, predFlagLXB0 and predFlagLXB1, with
X being 0 or 1.
  - the reference indices refIdxLXA0, refIdxLXA1, refIdxLXB0 and refIdxLXB1, with X being 0 or 1,
  - the motion vectors mvLXA0, mvLA1, mvLB0 and mvLXB1, with X being 0 or 1,
  - a variable colPic. specifying the collocated picture.
Outputs of this process are:
  - The modified array MvLX specifying the motion vectors of the current picture, with X = 0,1,
  - The modified array RefIdxLX specifying the reference indices of the current picture, with X = 0,1,
  - The modified array PredFlagLX specifying the prediction list utilization flags of the picture, with X = 0,1,
The the luma location (xCurrCtu, yCurrCtu) of the CTU that contains the current coding block is derived as
follows:
```

| | |
|---|---|
| xCurrCtu = (xCb>>CtuLog2Size)<<CtuLog2Size | (X-XX) |
| yCurrCtu = (yCb>>CtuLog2Size)<<CtuLog2Size | (X-XX) |

The variables subBlkLog2Width and subBlkLog2Height are derived as follows:

| | |
|---|---|
| subBlkLog2Size = log2_atmvp_sub_block_size_active_minus + 2 | (X-XX) |
| subBlkLog2Width = Log2((nCbW < (1<<subBlkLog2Size))? nCbW : (1<<subBlkLog2Size)) | (X-XX) |
| subBlkLog2Height = Log2((nCbH<(1<<subBlkLog2Size))?nCbH: (1<<subBlkLog2Size)) | (X-XX) |

```
Depending on the values of slice_type, collocated_from_l0_flag, and collocated_ref_idx, the variable colPic,
specifying the collocated picture, is derived as follows:
  - If slice_type is equal to B and collocated_from_l0_flag is equal to 0, colPic is set equal to
    RefPicList1[ collocated_ref_idx ].
  - Otherwise (slice_type is equal to B and collocated_from_l0_flag is equal to 1 or slice_type is equal to P),
    colPic is set equal to RefPicList0[ collocated_ref_idx ].
The decoding process for advance temporal motion vector prediction mode consists of the following ordered steps:
```

| 1. | The derivation process for motion parameters for collocated block as specified in subclause 1.1 is invoked | | | | | | | | |
|---|---|---|---|---|---|---|---|---|---|
| | with the availability flags availableFlagA0, availableFlagA1, availableFlagB0 and availableFlagB1, the | | | | | | | | |
| | prediction list utilization flags predFlagLXA0, predFlagLXA1, predFlagLXB0 and predFlagLXB1, the | | | | | | | | |
| | reference indices refIdxLXA0, refIdxLXA1, refIdxLXB0 and refIdxLXB1 and the motion vectors | | | | | | | | |
| | mvLXA0, mvLXA1, mvLXB0 and mvLXB1, with X being 0 or 1, the coding block location | | | | | | | | |
| | ( xCb+(nCbW>>1), yCb+(nCbH>>1) ) and the collocated picture colPic as input and the motion vectors | | | | | | | | |
| | colMvLX. the prediction list utilization flags colPredFlagLX and the reference indices colRefIdxLX of | | | | | | | | |
| | the collocated block, and one motion vector mvCol as output, with X=0,1. | | | | | | | | |
| 2. | The motion data of each subBlkWidth [symbol] subBlkHeight prediction block is derived by applying the | | | | | | | | |
| | following steps with xPb = 0, . . . , (nCbW>>subBlkLog2Width) −1 and yPb = 0, . . . , | | | | | | | | |
| | (nCbH>>subBlkLog2Height)−1: | | | | | | | | |
| | - | The luma location (xColPb, yColPb) of the collocated block of the prediction block inside the | | | | | | | |
| | | collocated picture is derived as: | | | | | | | |
| | | xColPb = Clip3(xCurrCtu, | | | | | | | |
| | | min(CurPicWidthInSamplesY −1, xCurrCtu + (1<<CtuLog2Size) + 3), xCb + | | | | | | | |
| | | (xPb<<subBlkLog2Width) + (mvCol[0]>>4)) | | | | | | | (X-XX) |
| | | yColPb = Clip3(yCurrCtu, | | | | | | | |
| | | min(CurPicHeightInSamplesY−1,yCurrCtu + (1<<CtuLog2Size) + 3), yCb + | | | | | | | |
| | | (yPb<<subBlkLog2Height) + (mvCol[1]>>4)) | | | | | | | (X-XX) |
| | - | The motion vectos pbMvLX, the prediction list utilization flags pbPredFlagLX and the | | | | | | | |
| | | reference indices pbRefIdxLX, with X=0.1, of the prediction block are derived by invoking the | | | | | | | |
| | | derivation precess of temporal motion vector components and reference indices for prediction | | | | | | | |
| | | block as specified in subclause 1.2 with the luma sample location (xCoIPb, yCoIPb) of the | | | | | | | |
| | | collocated block, colPic, colMvLX, colRefIdxLX and colPredFlagLX, with X=0,1, as inputs. | | | | | | | |
| | - | The variables MvLX[xSb][ySb], RefIdxLX[xSb][ySb]and PredFlagLX[xSb][ySb], with X=0.1, | | | | | | | |
| | | of the sub-blocks within the prediction block are dervied as follows with xSb = (nCbW>>2), . . . , | | | | | | | |
| | | (nCbW>>2)+subBlkLog2Width−1, ySb = (nCbH>>2), . . . , (nCbH>>2)+subBlkLog2Height−1: | | | | | | | |
| | | MvL0[xSb][ySb]= pbMvL0 | | | | | | | (X-XX) |
| | | MvL1[xSb][ySb] = pbMvL1 | | | | | | | (X-XX) |
| | | RefIdxL0[xSb][ySb] = pbRefIdxL0 | | | | | | | (X-XX) |
| | | RefIdxL1[xSb][ySb] = pbRefIdxL1 | | | | | | | (X-XX) |
| | | PredFlagL0[xSb][ySb] = pbPredFlagL0 | | | | | | | (X-XX) |
| | | PredFlagL1[xSb][ySb] = pbPredFlagL1 | | | | | | | (X-XX) |
| | | 1.1 Derivation process of motion parameters for collocated block | | | | | | | |
| | | Inputs to this process are: | | | | | | | |
| | | - a luma location (xCb, yCb) specifying the top-left luma sample of the collocated block relative to the top-left | | | | | | | |
| | | luma sample of the collocated picture. | | | | | | | |
| | | - the availability flags availableFlagA0, availableFlagA1, availableFlagB0 and availableFlagB1, | | | | | | | |
| | | - the prediction list utilization flags predFlagLXA0, predFlagLXA1, predFlagLXB0, predFlagLXB1 with X | | | | | | | |
| | | being 0 or 1, | | | | | | | |
| | | - the reference indices refIdxLXA0, refIdxLXA1, refIdxLXB0 and refIdxLB1, with X being 0 or 1, | | | | | | | |
| | | - the motion vectors mvLXA0, mvLXA1, mvLXB0 and mvLXB1, with X being 0 or 1. | | | | | | | |
| | | - a variable coIPic, specifying the collocated picture. | | | | | | | |
| | | Outputs of this process are: | | | | | | | |
| | | - the motion vectors colMvLX, with X being 0 or 1, | | | | | | | |
| | | - the prediction list utilization flags colPredFlagLX, with X being 0 or 1, | | | | | | | |
| | | - the reference indices colRefIdxLX of the collocated block, | | | | | | | |
| | | - the temporal motion vector vector mvCol. | | | | | | | |
| | | colPredFlagLX and colRefIdxLX, with X being 0 or 1, are set equal to 0 and a variable candStop is set equal to | | | | | | | |
| | | FALSE. | | | | | | | |
| | | colMvLX, with X being 0 or 1, are set equal to (0, 0). | | | | | | | |
| | | mvCol is set equal to (0, 0). | | | | | | | |
| | | For i in the range of 0 to (slice_type = = B) ? 1: 0, inclusive, the following applies: | | | | | | | |
| | - | If DiffPicOrderC [symbol] (aPic, currPic) is less than or equal to 0 for every picture aPic in every reference picture | | | | | | | |
| | | list of the current slice, slice_type is equal to B and collocated_from_l0_flag is equal to 0, X is set equal | | | | | | | |
| | | to (1 − i). | | | | | | | |
| | - | Otherwise, X is set equal to i. | | | | | | | |
| | | mvCol is derived as following step order: | | | | | | | |
| | | 1. | If candStop is equal to FALSE, availableFlagLXA0 is set equal to 1 and DiffPicOrderCnt(colPic, | | | | | | |
| | | | RefPicListX[refIdxLXA0]) is equal to 0, the following applies: | | | | | | |
| | | | - mvCol = mvLXA0 | | | | | (X-XX) | |
| | | | - candStop = TRUE | | | | | (X-XX) | |
| | | 2. | If candStop is equal to FALSE, availableFlagLXB0 is set equal to 1. and DiffPicOrderCnt(colPic, | | | | | | |
| | | | RefPicListX[refIdxLXB0]) is equal to 0, the following applies: | | | | | | |
| | | | - mvCol = mvLXB0 | | | | | (X-XX) | |
| | | | - candStop = TRUE | | | | | (X-XX) | |
| | | 3. | If candStop is equal to FALSE, availableFlagLXB1 is set equal to 1. and DiffPicOrderCnt(colPic, | | | | | | |
| | | | RefPicListX[refIdxLXB1]) is equal to 0, the following applies: | | | | | | |
| | | | - mvCol = mvLXB1 | | | | | (X-XX) | |
| | | | - candStop = TRUE | | | | | (X-XX) | |
| | | 4. | If candStop is equal to FALSE, availableFlagLXA1 is set equal to 1. and DiffPicOrderCnt(colPic, | | | | | | |
| | | | RefPicListX[refIdxLXA1]) is equal to 0, the following applies: | | | | | | |
| | | | - mvCol = mvLXA1 | | | | | (X-XX) | |
| | | | - candStop = TRUE | | | | | (X-XX) | |
| | The luma location (xColPb, yColpb) of the collocated block of the prediction block inside the collocated picture | | | | | | | | |
| | is derived as: | | | | | | | | |
| | | xColPb = Clip3(xCurrCtu, | | | | | | | |
| | | | min(CurPicWidthInSamplesY−1, xCurrCtu + (1<<CtuLog2Size) + 3), xCb + (mvCol[0]>>4)) | | | | | | (X-XX) |
| | | yColPb = Clip3(yCurrCtu, | | | | | | | |
| | | | min(CurPicHeightInSamplesY−1,yCurrCtu + (1<<CtuLog2Size) + 3), yCb + (mvCol[1]>>4)) | | | | | | (X-XX) |
| | The array colPredMode[x][y] is set equal to the prediction mode array of the collocated picture specified by colPic. | | | | | | | | |
| | - If colPredMode[xColPb>>2][yColPb>>2] is equal MODE_INTER, the following applies: | | | | | | | | |
| | | - | The derivation process for temporal motion vector prediction in subclause 1.3 is invoked the luma sample | | | | | | |
| | | | location (xColPb, yColPb), colPic, colRefIdxL0 as inputs and the output being assigned to colMvL0 and | | | | | | |
| | | | colPredFlagL0. | | | | | | |
| | | - | The derivation process for temporal motion vector prediction in subclause 1.3 is invoked the luma sample | | | | | | |
| | | | location (xColPb, yColPb), colPic, colRefIdxL1 as inputs and the output being assigned to colMvL1 and | | | | | | |
| | | | colPredFlagL1. | | | | | | |
| | | 1.2 Derivation process of temporal parameters for prediction block | | | | | | | |
| | | Inputs to this process are: | | | | | | | |
| | | - a luma location ( xColpb, yColPb ) specifying the top-left luma sample of the collocated block relative to the | | | | | | | |
| | | top-left luma sample of the collocated picture. | | | | | | | |
| | | - the collocated picture colPic. | | | | | | | |
| | | - the motion vectors colMvLX with X = 0,1 | | | | | | | |
| | | - the reference indices colRefIdxLX, with X = 0,1 | | | | | | | |
| | | - the prediction list utilization flags colPredFlagLX, with X = 0,1, | | | | | | | |
| | | Outputs of this process are: | | | | | | | |
| | | - the motion vectors pbMvLX of the prediction block, with X = 0,1 | | | | | | | |
| | | - the reference indices pbRefIdxLX of the prediction block, with X = 0,1 | | | | | | | |
| | | - the prediction list utilization flags pbPredFlagLX of the prediction block, with X = 0,1. | | | | | | | |
| | | The array colPredMode[ x ][ y ] is set equal to the prediction array of the collocated picture specified by | | | | | | | |
| | | colPic. | | | | | | | |
| | | 1. | If colPredMode[xColPb>>2][yColPb>>2] is equal to MODE_INTER, the following applies: | | | | | | |
| | | - | The refernce indices pbRefIdxLX, with x = 0,1 are set equal to 0, | | | | | | |
| | | - | The derivation process for temporal motion vector prediction in subclause 1.3 is invoked the luma sample | | | | | | |
| | | | location (xColPb, yColPb), colPic, pbRefIdxL0 as inputs and the output being assigned to pbMvL0 and | | | | | | |
| | | | pbPredFlagL0. | | | | | | |
| | | - | The derivation process for temporal motion vector prediction in subclause 1.3 is invoked the luma sample | | | | | | |
| | | | location (xColPb, yColPb), colPic, pbRefIdxL1 as inputs and the output being assigned to pbMvL1 and | | | | | | |
| | | | pbPredFlagL1. | | | | | | |
| | | 2. | Otherwise (colPredMode[xColPb>>2][yColPb>>2] is equal to MODE_INTRA), the following applies: | | | | | | |
| | | | pbMvL0 = colMvL0 | | | | | (X-XX) | |
| | | | pbMvL1 = colMvL1 | | | | | (X-XX) | |
| | | | pbRefIdxL0 = colRefIdxL0 | | | | | (X-XX) | |
| | | | pbRefIdxL1 = colRefIdxL1 | | | | | (X-XX) | |
| | | | pbPredFlagL0 = colPredFlagL0 | | | | | (X-XX) | |
| | | | pbPredFlagL1 = colPredFlagL1 | | | | | (X-XX) | |
| | | 1.3 Derivation process for temporal motion vector prediction | | | | | | | |
| | | Inputs of this process are | | | | | | | |
| | | - a luma location ( xColPb, yColPb ) specifying the top-left luma sample of the collocated block relative to the | | | | | | | |
| | | top-left luma sample of the collocated picture. | | | | | | | |
| | | - the collocated picture colPic. | | | | | | | |
| | | - a reference index [symbol] IdxLX, with X being 0 or 1. | | | | | | | |
| | | Outputs of this process are | | | | | | | |
| | | - the motion vector mvLXCol | | | | | | | |
| | | - the prediction list utilization flag predFlagLX | | | | | | | |
| | | The array colPredMode[ x ][ y ] is set equal to the prediction mode array of the collocated picture specified by | | | | | | | |
| | | colPic. | | | | | | | |
| | | The arrays colPredFlagLX [ x ][ y ], colMvLXCol[ x ][ y ], and colRefIdxLX [ x ][ y ] are set equal to the | | | | | | | |
| | | corresponding arrays of the collocated picture specified by colPic, PredFlagLX[ x ][ y ], MvLX[ x ][ y ], and | | | | | | | |
| | | RefIdxLX[ x ][ y ], respectively, with X being the value of X this process is invoked for. | | | | | | | |
| | | The variable currPic specifies the current picture. | | | | | | | |
| | | The variables mvLXCol and predFlagLX are derived as follows: | | | | | | | |
| | | | | | - | If colPredMode[xColPh>>2][yColPb>>2] is MODE_INTRA. both components of mvLXCol | | | |
| | | | | | | are set to 0 and predFlagLX is set to 0. | | | |
| | | | | | - | Otherwise, the motion vector mvCol, the reference index refIdxCol. and the reference list | | | |
| | | | | | | identifier listCol are derived as follows: | | | |
| | | | - | If colPredFlagLX[ xColPb >>2][ yColPb >>2] is equal to 1. predFlagLX is set to 1 and mvCol. refIdxCol. | | | | | |
| | | | | and listCol are set equal to colMvLX [ xColPb >>2][ yColPb >>2], colRefIdxLX | | | | | |
| | | | | [ xColPb>>2 ][ yColPb>>2 ], and LX, respectively. | | | | | |
| | | | - | Otherwise (colPredFlagLX[ xColPb >>2][ yColPb >>2] is equal to 0), the following applies: | | | | | |
| | | | | - | If DiffPicOrderC [symbol] ( aPic, currPic ) is less than or equal to 0 for every picture aPic in every reference | | | | |
| | | | | | picture list of the current slice and colPredFlagLN[xColPb>>2][yColPb>>2] is equal to 1, mvCol. | | | | |
| | | | | | refIdxCol. and listCol are set equal to colMvLX[ xColPb>>2 ][ yColPb>>2 ], | | | | |
| | | | | | refIdxLXCol[ xColPb>>2 ][ yColPb>>2 ] and LN, respectively, with N being equal to 1-X where X | | | | |
| | | | | | being the value of X this process is invoked for. | | | | |
| | | | | - | Otherwise, both components of LXCol are set to 0 and predFlagLX is set to 0. | | | | |
| | | | | - | If predFlagLX is equal to 1, the variables mvLXCol and predFlagLX are derived as follows: | | | | |
| | | | | | - | refPicListCol[ refIdxCol ] is set to be the picture with reference index refIdxCol in the reference | | | |
| | | | | | | picture list listCol of the collocated picture colPic, | | | |
| | | | | | | | colP [symbol] cDiff = DiffPicOrderCnt( colPic, setPicListCol[ setIdxCol ] ) | (X-XX) | |
| | | | | | | | currP [symbol] cDiff = DiffPicOrderCnt( currPic, RefPicListX[ refIdxLX ] ) | (X-XX) | |
| | | | | | - | If colPocDiff is equal to currPocDiff. mvLXCol is derived as follows: | | | |
| | | | | | | | mvLXCol = mvCol | (X-XX) | |
| | | | | | - | Otherwise mvLXCol is derived as a scaled version of the motion vector mvCol as follows: | | | |
| | | | | | | | [symbol] x = ( 16384 + ( Abs( [symbol] d ) >> 1 ) ) / [symbol] d | (X-XX) | |
| | | | | | | | distScaleFactor = Clip3( −4096, 4095, ( [symbol] b * [symbol] x + 32 ) >> 6 ) | (X-XX) | |
| | | | | | | | mvLXCol = Clip3( −32768, 32767, Sign( distScaleFactor * mvCol ) | | |
| | | | | | | | ( ( Abs( distScaleFactor * mvCol )+ 127 ) >> [symbol] ) ) | (X-XX) | |
| | | | | | | | where [symbol] d and [symbol] b are derived as follows: | | |
| | | | | | | | [symbol] d = Clip3( −128, 127, colPocDiff ) | (X-XX) | |
| | | | | | | | [symbol] b = Clip3( −128, 127, currPocDiff ) | (X-XX) | |

[symbol]

indicates data missing or illegible when filed

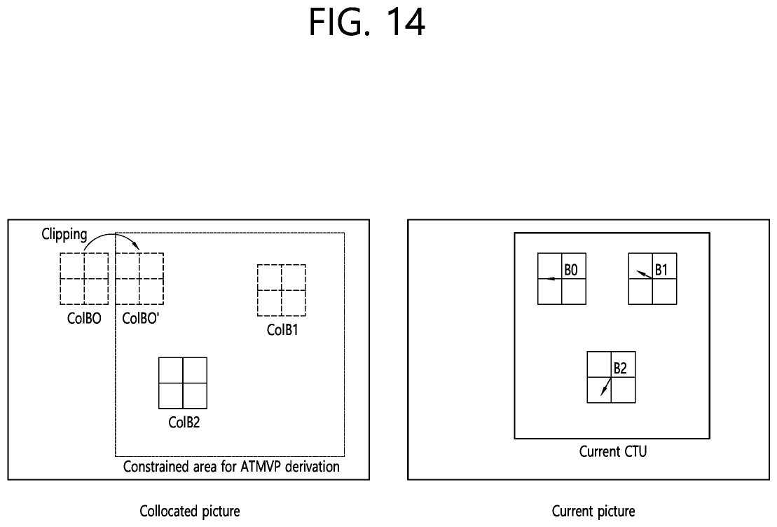

In addition, in the present disclosure, a corresponding block used to derive an ATMVP candidate may be specified within a constrained area. This will be described with reference to FIG. 14.

FIG. 14 is a diagram for explaining an example in which a restricted area is applied when inducing an ATMVP candidate.

Referring to FIG. 14, there may be a current coding tree unit (CTU) in a current picture, and current blocks B0, B1, and B2 for performing inter prediction by applying ATMVP in the current CTU. In order to derive a temporal motion information candidate (ATMVP candidate) of a sub-block unit for the current block by applying the ATMVP mode, first, a corresponding block (col block) (ColB0, ColB1, and ColB2) may be derived in a reference picture (col picture) for each of the current blocks B0, B1, and B2. In this case, a restricted area may be applied to the reference picture (col picture). In an example, a region obtained by adding one column of 4×4 blocks to the current CTU within the reference picture may be determined as the restriction area. In other words, the restricted area may mean an area obtained by adding one column of 4×4 blocks to a CTU area located correspondingly to a current CTU on a reference picture.

For example, as shown in FIG. 14, when the corresponding block (ColB0) located correspondingly to the current block (B0) is located outside the restricted area on the reference picture, the corresponding block ColB0 can be clipped so that it can be located within the restricted area. In this case, the corresponding block ColB0 may be clipped to the nearest boundary of the restricted area and adjusted to the corresponding block ColB0′.

According to the example of the present disclosure described above, hardware complexity is improved by reducing the amount of fetching data from memory in the same area unit. In addition, to improve the worst case, a method of controlling the process of deriving temporal motion information candidates of a sub-block unit is proposed. In addition to the conventional video compression technology, the latest video compression technology divides a picture into blocks of various types to perform prediction and coding. Further, in order to improve prediction performance and coding efficiency, it is divided into small blocks such as 4×4, 4×8, and 8×4. When it is divided into small blocks like this, a case in which the current block is smaller than the unit with which the temporal motion vector is fetched (i.e., the minimum sub-block size) may occur in deriving the temporal motion information candidate on a sub-block unit basis. In this case, as memory fetching occurs with a current block size (i.e., minimum prediction unit size) smaller than the fetch unit (i.e., minimum sub-block size), a worst case occurs in terms of hardware. That is, in the present disclosure, under the consideration of this problem, as described above, a condition for determining whether or not a temporal motion information candidate of a sub-block unit is derived has been proposed, and a method of deriving the temporal motion information candidate of a sub-block unit only when the above conditions are satisfied has been proposed.

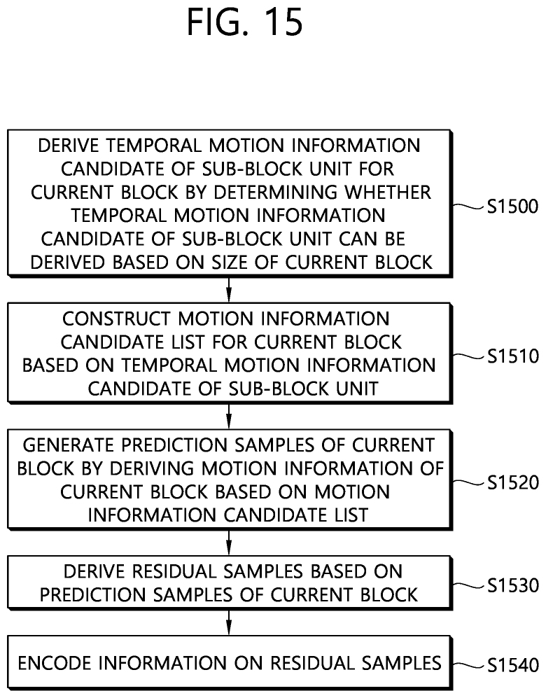

FIG. 15 is a flowchart schematically illustrating an image encoding method by an encoding apparatus according to the present disclosure.

The method of FIG. 15 may be performed by the encoding apparatus 200 of FIG. 2. More specifically, steps S1500 to S1520 may be performed by the predictor 220 disclosed in FIG. 2, step S1530 may be performed by the residual processor 230 disclosed in FIG. 2, and step S1540 may be performed by the entropy encoder 240 disclosed in FIG. 2. In addition, the method disclosed in FIG. 15 may include the examples described above in the present disclosure. However, an explanation for the specific content in FIG. 15 duplicated with contents described above with reference to FIGS. 1 to 14 will be omitted or made briefly.

Referring to FIG. 15, the encoding apparatus may derive a temporal motion information candidate of a sub-block unit for a current block by determining whether a temporal motion information candidate of a sub-block unit can be derived based on the size of the current block (S1500).

In an example, in performing inter prediction on a current block, the encoding apparatus may determine whether to apply the prediction mode itself that derives a temporal motion information candidate (i.e., sbTMVP candidate) of a sub-block unit. In this case, the encoding apparatus may encode flag information (e.g., sps_sbtmvp_enabled_flag) for indicating whether to apply the prediction mode itself that derives a temporal motion information candidate (i.e., sbTMVP candidate) of a sub-block unit, and may signal it to the decoding apparatus. When applying the prediction mode that derives a temporal motion information candidate of a sub-block unit, the encoding apparatus may derive the temporal motion information candidate of a sub-block unit by determining whether the temporal motion information candidate of a sub-block unit can be derived based on the size of the current block.

In determining whether the temporal motion information candidate of a sub-block unit can be derived based on the size of the current block, the encoding apparatus may determine depending on whether the size of the current block is smaller than the minimum sub-block size. In an example, it may be expressed as Equation 1 below. When the condition of Equation 1 below is satisfied, the encoding apparatus may determine that the temporal motion information candidate of a sub-block unit cannot be derived. Alternatively, when the condition of Equation 1 below is not satisfied, the encoding apparatus may determine that the temporal motion information candidate of a sub-block unit can be derived.

Condition=Width_{block}≤MIN_SUB_BLOCK_SIZE∥Height_{block}≤MIN_SUB_BLOCK_SIZE [Equation 1]

Here, the minimum sub-block size may be predetermined, and for example, may be predefined as an 8×8 size. However, the 8×8 size is only an example, and may be defined as a different size under the consideration of hardware performance or coding efficiency of the encoder/decoder. For example, the minimum sub-block size may be 8×8 or more, or may be also set as a size smaller than x. In addition, information on the minimum sub-block size may be signaled from the encoding apparatus to the decoding apparatus.

When the size of the current block (Width_{block}, Height_{block}) is smaller than the minimum sub-block size, then the encoding apparatus may determine that the temporal motion information candidate of a sub-block unit cannot be derived for the current block, and may not perform a process of deriving the temporal motion information candidate of a sub-block unit for the current block. In this case, a motion information candidate list can be constructed excluding the temporal motion information candidate of a sub-block unit. For example, when the minimum sub-block size is predefined as an 8×8 size and the current block size is any one of 4×4, 4×8, or 8×4, the encoding apparatus may determine that the size of the current block is smaller than the minimum sub-block size, and may not derive the temporal motion information candidate of a sub-block unit for the current block.

When the size of the current block (Width_{block}, Height_{block}) is larger than the minimum sub-block size, then the encoding apparatus may determine that the temporal motion information candidate of a sub-block unit can be derived for the current block, and may derive the temporal motion information candidate of a sub-block unit for the current block. For example, when the minimum sub-block size is predefined as 8×8 size and the size of the current block is larger than 8×8 size, the encoding apparatus may divide the current block into sub-blocks of a fixed size, and derive a temporal motion information candidate of a sub-block unit for the current block based on motion vectors of the sub-blocks in the corresponding block corresponding to the sub-blocks in the current block.

In dividing the current block into sub-blocks of a fixed size, as described with reference to FIGS. 11 to 13, the sub-block size may be set to a fixed size, since it may affect the process of fetching the motion vector of the corresponding block from the reference picture depending on the sub-block size. As an example, the sub-block size is a fixed size, and may be, for example, 8×8, 16×16, or 32×32. That is, the encoding apparatus may divide the current block into fixed sub-block units having a size of 8×8, 16×16, or 32×32 to derive the temporal motion vector for each divided sub-block. Here, the sub-block size of a fixed size may be predefined or may be signaled from the encoding apparatus to the decoding apparatus. A method of signaling the sub-block size has been described in detail with reference to Tables 5 to 16.

In deriving motion vectors of sub-blocks in the corresponding block corresponding to sub-blocks in the current block, there may be a case where no motion vectors exist in a specific sub-block in the corresponding block. That is, when the motion vector of a specific sub-block in the corresponding block is not available, the encoding apparatus may derive a motion vector of a block located at the center of the corresponding block, and use it as a motion vector for a sub-block in the current block corresponding to the specific sub-block in the corresponding block. Here, the block located at the center of the corresponding block may refer to a block including a center bottom-right sample of the corresponding block. The center bottom-right sample of the corresponding block may refer to a bottom-right sample among four samples, which is located at the center of the corresponding block.

In deriving the temporal motion information candidate of a sub-block unit for the current block, the encoding apparatus may specify a corresponding block located correspondingly to the current block in the reference picture based on a motion vector of a spatial neighboring block of the current block. In addition, the encoding apparatus may derive the motion vectors of a sub-block unit for the corresponding block specified on the reference picture, and use them as motion vectors (i.e., temporal motion information candidate) of a sub-block unit for the current block.

The spatial neighboring block may be derived by checking availability based on neighboring blocks including at least one of a bottom-left corner neighboring block, a left neighboring block, a top-right corner neighboring block, a top neighboring block, and a top-left corner neighboring block of the current block. In this case, the spatial neighboring block may include a plurality of neighboring blocks, or may include only one neighboring block (e.g., a left neighboring block). When multiple neighboring blocks are used as spatial neighboring blocks, availability may be checked while searching the plurality of neighboring blocks in a predetermined order, and the motion vector of the neighboring block determined to be first available may be used. Since this has been described in detail with reference to FIG. 7, detailed descriptions thereof will be omitted.

Further, the temporal motion information candidate of a sub-block unit for the current block may be derived based on motion vectors of a sub-block unit of a corresponding block (or col block) located correspondingly to the current block in the reference picture (or col picture). The corresponding block may be derived in the reference picture based on the motion vector of the spatial neighboring block of the current block. For example, the position of the corresponding block in the reference picture may be specified by the top-left sample of the corresponding block, and the top-left sample position of the corresponding block may correspond to a position moved by the motion vector of the spatial neighboring block from the top-left sample position of the current block on the reference picture. In addition, the size (width/height) of the corresponding block may be the same as the size (width/height) of the current block.

Since the process of deriving the temporal motion information candidate of a sub-block unit has been described in detail with reference to FIGS. 7 to 14, detailed descriptions thereof will be omitted in this example. Of course, the examples disclosed in FIGS. 7 to 14 may also be applied to the present example.

The encoding apparatus may construct a motion information candidate list for the current block based on the temporal motion information candidate of a sub-block unit (S1510).

The encoding apparatus may add the temporal motion information candidate of a sub-block unit for the current block to the motion information candidate list. At this time, the encoding apparatus may compare the number of current candidates with the maximum candidate number required to construct a motion information candidate list, and may add a combined bi-predictive candidate and a zero vector candidate to the motion information candidate list when the number of current candidates is smaller than the maximum candidate number according to the comparison result. The maximum candidate number may be predefined, or may be signaled from the encoding apparatus to the decoding apparatus.

Depending on example, the encoding apparatus may construct the motion information candidate list including both the spatial motion information candidate and the temporal motion information candidate as described with reference to FIGS. 4, 5, and 10, or may construct the motion information candidate list for the temporal motion information candidate of a sub-block unit. That is, the encoding apparatus may generate the motion information candidate list by differently constructing the number of candidates or candidates constructed according to an inter prediction mode applied during inter prediction. For example, when a merge mode is applied, the encoding apparatus may generate the merge candidate list by constructing the merge candidate based on the spatial motion information candidate and the temporal motion information candidate. At this time, when the ATMVP mode or the ATMVP-ext mode is applied in deriving the temporal motion information candidate, it may be constructed by adding a temporal motion information candidate (ATMVP candidate or ATMVP-ext candidate) of a sub-block unit to the merge candidate list. Alternatively, as described above, when the prediction mode that derives the sbTMVP candidate is applied according to flag information (e.g., sps_sbtmvp_enabled_flag) for indicating whether to apply the prediction mode itself that derives the temporal motion information candidate (i.e., sbTMVP candidate) of a sub-block unit, the encoding apparatus may derive the sbTMVP candidate and construct the motion information candidate list for the sbTMVP candidate. In this case, the candidate list for the temporal motion information candidate of a sub-block unit may be referred to as the sub-block merge candidate list.

Since the process of constructing the motion information candidate list has been described in detail with reference to FIGS. 4, 5, and 10, detailed descriptions thereof will be omitted in this example. Of course, the examples disclosed in FIGS. 4, 5 and 10 may also be applied to the present example.

The encoding apparatus may generate prediction samples of the current block by deriving motion information of the current block based on the motion information candidate list (S1520).

As an example, the encoding apparatus may select an optimal motion information candidate from among motion information candidates included in the motion information candidate list based on a rate-distortion (RD) cost, and the selected motion information candidate may be derived as motion information of the current block. In addition, the encoding apparatus may generate prediction samples of the current block by performing inter prediction on the current block based on motion information of the current block. For example, when the temporal motion information candidate (ATMVP candidate or ATMVP-ext candidate) of a sub-block unit is selected from among the motion information candidates included in the motion information candidate list, the encoding apparatus may derive motion vectors of a sub-block unit of the current block and generate prediction samples of the current block based on the derived motion vectors.

The encoding apparatus may derive residual samples based on the prediction samples of the current block (S1530), and may encode information on the residual samples (S1540).

That is, the encoding apparatus may generate the residual samples based on original samples for the current block and prediction samples of the current block. In addition, the encoding apparatus may encode information on the residual samples, output it as a bitstream, and transmit it to the decoding apparatus through a network or a storage medium.

In addition, the encoding apparatus may encode information on the motion information candidate selected from the motion information candidate list based on a rate-distortion (RD) cost. For example, the encoding apparatus may encode candidate index information for indicating a motion information candidate to be used as motion information of the current block in the motion information candidate list, and may signal it to the decoding apparatus.

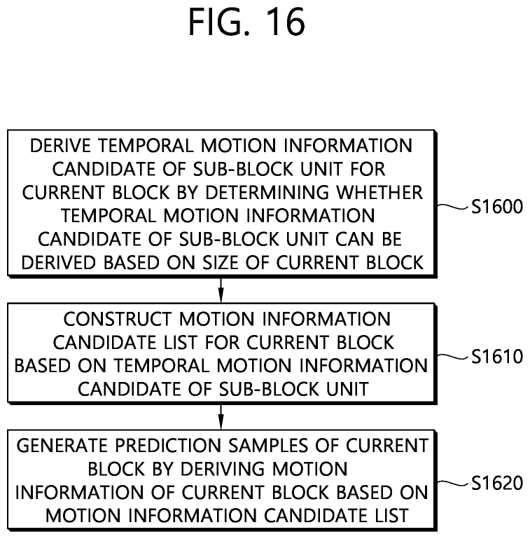

FIG. 16 is a flowchart schematically illustrating an image decoding method by a decoding apparatus according to the present disclosure.

The method of FIG. 16 may be performed by the decoding apparatus 300 of FIG. 3. More specifically, steps S1600 to S1620 may be performed by the predictor 330 disclosed in FIG. 3. In addition, the method disclosed in FIG. 16 may include the examples described above in the present disclosure. However, an explanation for the specific content in FIG. 16 duplicated with contents described above with reference to FIGS. 1 to 14 will be omitted or made briefly.

Referring to FIG. 16, the decoding apparatus may derive a temporal motion information candidate of a sub-block unit for a current block by determining whether a temporal motion information candidate of a sub-block unit can be derived based on the size of the current block (S1600).

In an example, in performing inter prediction on a current block, the decoding apparatus may determine whether to apply the prediction mode itself that derives a temporal motion information candidate (i.e., sbTMVP candidate) of a sub-block unit. In this case, the decoding apparatus may receive from the encoding apparatus and decode flag information (e.g., sps_sbtmvp_enabled_flag) for indicating whether to apply the prediction mode itself that derives a temporal motion information candidate (i.e., sbTMVP candidate) of a sub-block unit, and may determine whether to apply the prediction mode itself that derives the sbTMVP candidate. When applying the prediction mode that derives a temporal motion information candidate of a sub-block unit, the decoding apparatus may derive the temporal motion information candidate of a sub-block unit by determining whether the temporal motion information candidate of a sub-block unit can be derived based on the size of the current block.

In determining whether the temporal motion information candidate of a sub-block unit can be derived based on the size of the current block, the decoding apparatus may determine depending on whether the size of the current block is smaller than the minimum sub-block size. As an example, when the condition of Equation 1 above is satisfied, the decoding apparatus may determine that the temporal motion information candidate of a sub-block unit cannot be derived. Alternatively, when the condition of Equation 1 above is not satisfied, the decoding apparatus may determine that the temporal motion information candidate of a sub-block unit can be derived.

Here, the minimum sub-block size may be predetermined, and for example, may be predefined as an 8×8 size. However, the 8×8 size is only an example, and may be defined as a different size under the consideration of hardware performance or coding efficiency of the encoder/decoder. For example, the minimum sub-block size may be 8×8 or more, or may be also set as a size smaller than 8×8. In addition, information on the minimum sub-block size may be signaled from the encoding apparatus to the decoding apparatus.

When the size of the current block (Width_{block}, Height_{block}) is smaller than the minimum sub-block size, then the decoding apparatus may determine that the temporal motion information candidate of a sub-block unit cannot be derived for the current block, and may not perform a process of deriving the temporal motion information candidate of a sub-block unit for the current block. In this case, a motion information candidate list can be constructed excluding the temporal motion information candidate of a sub-block unit. For example, when the minimum sub-block size is predefined as an 8×8 size and the current block size is any one of 4×4, 4×8, or 8×4, the decoding apparatus may determine that the size of the current block is smaller than the minimum sub-block size, and may not derive the temporal motion information candidate of a sub-block unit for the current block.

When the size of the current block (Width_{block}, Height_{block}) is larger than the minimum sub-block size, then the decoding apparatus may determine that the temporal motion information candidate of a sub-block unit can be derived for the current block, and may derive the temporal motion information candidate of a sub-block unit for the current block. For example, when the minimum sub-block size is predefined as 8×8 size and the size of the current block is larger than 8×8 size, the decoding apparatus may divide the current block into sub-blocks of a fixed size, and derive a temporal motion information candidate of a sub-block unit for the current block based on motion vectors of the sub-blocks in the corresponding block corresponding to the sub-blocks in the current block.

In dividing the current block into sub-blocks of a fixed size, as described with reference to FIGS. 11 to 13, the sub-block size may be set to a fixed size, since it may affect the process of fetching the motion vector of the corresponding block from the reference picture depending on the sub-block size. As an example, the sub-block size is a fixed size, and may be, for example, 8×8, 16×16, or 32×32. That is, the decoding apparatus may divide the current block into fixed sub-block units having a size of 8×8, 16×16, or 32×32 to derive the temporal motion vector for each divided sub-block. Here, the sub-block size of a fixed size may be predefined or may be signaled from the encoding apparatus to the decoding apparatus. A method of signaling the sub-block size has been described in detail with reference to Tables 5 to 16.

In deriving motion vectors of sub-blocks in the corresponding block corresponding to sub-blocks in the current block, there may be a case where no motion vectors exist in a specific sub-block in the corresponding block. That is, when the motion vector of a specific sub-block in the corresponding block is not available, the decoding apparatus may derive a motion vector of a block located at the center of the corresponding block, and use it as a motion vector for a sub-block in the current block corresponding to the specific sub-block in the corresponding block. Here, the block located at the center of the corresponding block may refer to a block including a center bottom-right sample of the corresponding block. The center bottom-right sample of the corresponding block may refer to a bottom-right sample among four samples, which is located at the center of the corresponding block.

In deriving the temporal motion information candidate of a sub-block unit for the current block, the decoding apparatus may specify a corresponding block located correspondingly to the current block in the reference picture based on a motion vector of a spatial neighboring block of the current block. In addition, the decoding apparatus may derive the motion vectors of a sub-block unit for the corresponding block specified on the reference picture, and use them as motion vectors (i.e., temporal motion information candidate) of a sub-block unit for the current block.

The spatial neighboring block may be derived by checking availability based on neighboring blocks including at least one of a bottom-left corner neighboring block, a left neighboring block, a top-right corner neighboring block, a top neighboring block, and a top-left corner neighboring block of the current block. In this case, the spatial neighboring block may include a plurality of neighboring blocks, or may include only one neighboring block (e.g., a left neighboring block). When multiple neighboring blocks are used as spatial neighboring blocks, availability may be checked while searching the plurality of neighboring blocks in a predetermined order, and the motion vector of the neighboring block determined to be first available may be used. Since this has been described in detail with reference to FIG. 7, detailed descriptions thereof will be omitted.

Further, the temporal motion information candidate of a sub-block unit for the current block may be derived based on motion vectors of a sub-block unit of a corresponding block (or col block) located correspondingly to the current block in the reference picture (or col picture). The corresponding block may be derived in the reference picture based on the motion vector of the spatial neighboring block of the current block. For example, the position of the corresponding block in the reference picture may be specified by the top-left sample of the corresponding block, and the top-left sample position of the corresponding block may correspond to a position moved by the motion vector of the spatial neighboring block from the top-left sample position of the current block on the reference picture. In addition, the size (width/height) of the corresponding block may be the same as the size (width/height) of the current block.

Since the process of deriving the temporal motion information candidate of a sub-block unit has been described in detail with reference to FIGS. 7 to 14, detailed descriptions thereof will be omitted in this example. Of course, the examples disclosed in FIGS. 7 to 14 may also be applied to the present example.

The decoding apparatus may construct a motion information candidate list for the current block based on the temporal motion information candidate of a sub-block unit (S1610).

The decoding apparatus may add the temporal motion information candidate of a sub-block unit for the current block to the motion information candidate list. At this time, the decoding apparatus may compare the number of current candidates with the maximum candidate number required to construct a motion information candidate list, and may add a combined bi-predictive candidate and a zero vector candidate to the motion information candidate list when the number of current candidates is smaller than the maximum candidate number according to the comparison result. The maximum candidate number may be predefined, or may be signaled from the encoding apparatus to the decoding apparatus.

Depending on example, the decoding apparatus may construct the motion information candidate list including both the spatial motion information candidate and the temporal motion information candidate as described with reference to FIGS. 4, 5, and 10, or may construct the motion information candidate list for the temporal motion information candidate of a sub-block unit. That is, the decoding apparatus may generate the motion information candidate list by differently constructing the number of candidates or candidates constructed according to an inter prediction mode applied during inter prediction. For example, when a merge mode is applied, the decoding apparatus may generate the merge candidate list by constructing the merge candidate based on the spatial motion information candidate and the temporal motion information candidate. At this time, when the ATMVP mode or the ATMVP-ext mode is applied in deriving the temporal motion information candidate, it may be constructed by adding a temporal motion information candidate (ATMVP candidate or ATMVP-ext candidate) of a sub-block unit to the merge candidate list. Alternatively, as described above, when the prediction mode that derives the sbTMVP candidate is applied according to flag information (e.g., sps_sbtmvp_enabled_flag) for indicating whether to apply the prediction mode itself that derives the temporal motion information candidate (i.e., sbTMVP candidate) of a sub-block unit, the decoding apparatus may derive the sbTMVP candidate and construct the motion information candidate list for the sbTMVP candidate. In this case, the candidate list for the temporal motion information candidate of a sub-block unit may be referred to as the sub-block merge candidate list.

Since the process of constructing the motion information candidate list has been described in detail with reference to FIGS. 4, 5, and 10, detailed descriptions thereof will be omitted in this example. Of course, the examples disclosed in FIGS. 4, 5 and 10 may also be applied to the present example.

The decoding apparatus may generate prediction samples of the current block by deriving motion information of the current block based on the motion information candidate list (S1520).

As an example, the decoding apparatus may select one of motion information candidates included in the motion information candidate list, which is indicated by a candidate index, and may derive it as motion information of the current block. In this case, the candidate index information may be an index indicating a motion information candidate to be used as motion information of a current block in the motion information candidate list. The candidate index information may be signaled from the encoding apparatus. In addition, the decoding apparatus may generate prediction samples of the current block by performing inter prediction on the current block based on motion information of the current block. For example, when the temporal motion information candidate (ATMVP candidate or ATMVP-ext candidate) of a sub-block unit is selected by the candidate index from among the motion information candidates included in the motion information candidate list, the decoding apparatus may derive motion vectors of a sub-block unit of the current block and generate prediction samples of the current block based on the derived motion vectors.

In addition, the decoding apparatus may derive residual samples based on residual information of the current block, and generate a reconstructed picture based on the derived residual samples and the prediction samples. In this case, the residual information may be signaled from the encoding apparatus.

In the above-described embodiments, the methods are explained on the basis of flowcharts by means of a series of steps or blocks, but the present disclosure is not limited to the order of steps, and a certain step may be performed in order or step different from that described above, or concurrently with another step. Further, it may be understood by a person having ordinary skill in the art that the steps shown in a flowchart are not exclusive, and that another step may be incorporated or one or more steps of the flowchart may be removed without affecting the scope of the present disclosure.

Embodiments described in the present document may be embodied and performed on a processor, a microprocessor, a controller or a chip. For example, functional units shown in each drawing may be embodied and performed on a computer, a processor, a microprocessor, a controller or a chip. In this case, information (e.g., information on instructions) or algorithm for embodiment may be stored in a digital storage medium.

Further, the decoding apparatus and the encoding apparatus to which the present disclosure is applied may be included in a multimedia broadcasting transceiver, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an over the top (OTT) video device, an internet streaming service providing device, a three-dimensional (3D) video device, a video telephony video device, a transportation means terminal (e.g., a vehicle terminal, an aircraft terminal, a ship terminal, etc.) and a medical video device, and may be used to process a video signal or a data signal. For example, the over the top (OTT) video device may include a game console, a Blu-ray player, an Internet access TV, a Home theater system, a smart phone, a Tablet PC, a digital video recorder (DVR) and the like.

In addition, the processing method to which the present disclosure is applied, may be produced in the form of a program executed by a computer, and be stored in a computer-readable recording medium. Multimedia data having a data structure according to the present disclosure may also be stored in a computer-readable recording medium. The computer-readable recording medium includes all kinds of storage devices and distributed storage devices in which computer-readable data are stored. The computer-readable recording medium may include, for example, a Blu-ray Disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media embodied in the form of a carrier wave (for example, transmission over the Internet). In addition, a bitstream generated by the encoding method may be stored in a computer-readable recording medium or transmitted through a wired or wireless communication network.

Additionally, the embodiments of the present disclosure may be embodied as a computer program product by program codes, and the program codes may be executed on a computer by the embodiments of the present disclosure. The program codes may be stored on a computer-readable carrier.

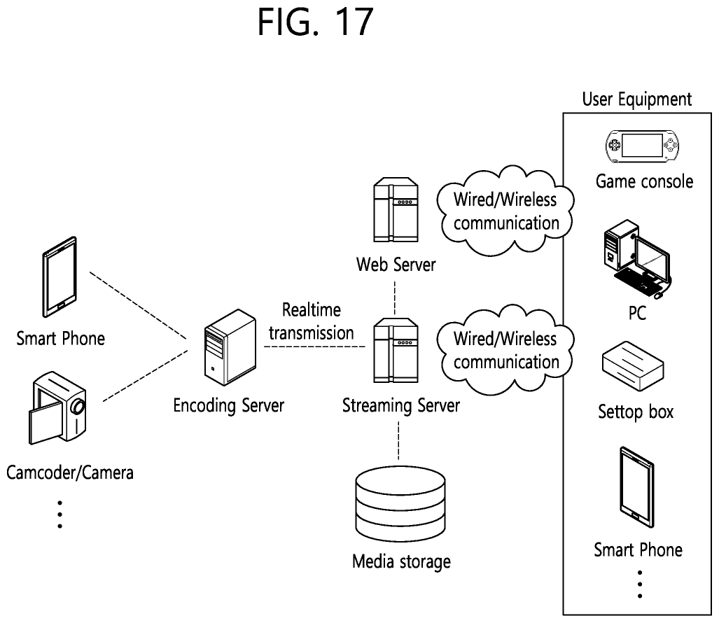

FIG. 17 illustrates an example of a content streaming system to which embodiments disclosed in this document may be applied.

The content streaming system to which the embodiment(s) of this document is applied may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present document is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. smartwatches, smart glasses, head mounted displays), digital TVs, desktops computer, digital signage, and the like.

Each server in the content streaming system may be operated as a distributed server, in which case data received from each server may be distributed.

What is claimed is:

1. An image decoding method performed by a decoding apparatus, the method comprising:
deriving a temporal motion information candidate of a sub-block unit for a current block by determining whether the temporal motion information candidate of the sub-block unit can be derived based on a size of the current block;
constructing a motion information candidate list for the current block based on the temporal motion information candidate of the sub-block unit; and
generating prediction samples of the current block by deriving motion information of the current block based on the motion information candidate list,
wherein the temporal motion information candidate of the sub-block unit for the current block is derived based on motion vectors of a sub-block unit of a corresponding block located correspondingly to the current block in a reference picture, and
the corresponding block is derived in the reference picture based on a motion vector of a spatial neighboring block of the current block.

2. The image decoding method of claim 1, wherein the step of deriving the temporal motion information candidate of the sub-block unit for the current block determines whether the temporal motion information candidate of the sub-block unit can be derived for the current block, depending on whether the size of the current block is smaller than a minimum sub-block size.

3. The image decoding method of claim 2, wherein the minimum sub-block size is predetermined as an 8×8 size.

4. The image decoding method of claim 3, wherein the step of deriving the temporal motion information candidate of the sub-block unit for the current block determines it is not possible to derive the temporal motion information candidate of the sub-block unit for the current block, by determining that a size of the current block is smaller than the minimum sub-block size when the size of the current block is any one of a 4×4, 4×8, or 8×4 size.

5. The image decoding method of claim 2, wherein information on the minimum sub-block size is signaled from an encoding apparatus.

6. The image decoding method of claim 1, wherein the step of deriving the temporal motion information candidate of the sub-block unit for the current block divides the current block into sub-blocks of a fixed size, and derives the temporal motion information candidate of the sub-block unit based on motion vectors of sub-blocks in the corresponding block corresponding to sub-blocks in the current block.

7. The image decoding method of claim 6, wherein the sub-block unit of the fixed size is a sub-block unit of a 8×8, 16×16 or 32×32 size.

8. The image decoding method of claim 1, wherein the motion vector of the spatial neighboring block of the current block is a motion vector of an available spatial neighboring block derived based on neighboring blocks including at least one of a bottom-left corner neighboring block, a left neighboring block, a top-right corner neighboring block, a top neighboring block, and a top-left corner neighboring block of the current block.

9. The image decoding method of claim 1, wherein the step of deriving the temporal motion information candidate of the sub-block unit for the current block derives a motion vector of a block located at a center of the corresponding block and uses it as a motion vector of a sub-block in the current block corresponding to a specific sub-block in the corresponding block, when a motion vector of the specific sub-block in the corresponding block is not available.

10. An image encoding method performed by an encoding apparatus, the method comprising:
deriving a temporal motion information candidate of a sub-block unit for a current block by determining whether the temporal motion information candidate of the sub-block unit can be derived based on the size of the current block;
constructing a motion information candidate list for the current block based on the temporal motion information candidate of the sub-block unit;
generating prediction samples of the current block by deriving motion information of the current block based on the motion information candidate list;
deriving residual samples based on the prediction samples of the current block; and
encoding information on the residual samples,
wherein the temporal motion information candidate of the sub-block unit for the current block is derived based on motion vectors of a sub-block unit of a corresponding block located correspondingly to the current block in a reference picture, and
the corresponding block is derived in the reference picture based on a motion vector of a spatial neighboring block of the current block.

11. The image encoding method of claim 10, wherein the step of deriving the temporal motion information candidate of the sub-block unit for the current block determines whether the temporal motion information of the sub-block unit can be derived for the current block, depending on whether the size of the current block is smaller than a minimum sub-block size.

12. The image encoding method of claim 11, wherein the minimum sub-block size is predetermined as an 8×8 size.

13. The image encoding method of claim 12, wherein the step of deriving the temporal motion information candidate of the sub-block unit for the current block determines it is not possible to derive the temporal motion information candidate of the sub-block unit for the current block, by determining that a size of the current block is smaller than the minimum sub-block size when the size of the current block is any one of a 4×4, 4×8, or 8×4 size.

14. The image encoding method of claim 11, wherein information on the minimum sub-block size is signaled from the encoding apparatus to a decoding apparatus.

15. The image encoding method of claim 10, wherein the step of deriving the temporal motion information candidate of the sub-block unit for the current block divides the current block into sub-blocks of a fixed size, and derives the temporal motion information candidate of the sub-block unit based on motion vectors of sub-blocks in the corresponding block corresponding to sub-blocks in the current block.

16. The image encoding method of claim 15, wherein the sub-block unit of the fixed size is a sub-block unit of a 8×8, 16×16 or 32×32 size.

17. The image encoding method of claim 10, wherein the motion vector of the spatial neighboring block of the current block is a motion vector of an available spatial neighboring block derived based on neighboring blocks including at least one of a bottom-left corner neighboring block, a left neighboring block, a top-right corner neighboring block, a top neighboring block, and a top-left corner neighboring block of the current block.

18. The image encoding method of claim 10, wherein the step of deriving the temporal motion information candidate of the sub-block unit for the current block derives a motion vector of a block located at a center of the corresponding block and uses it as a motion vector of a sub-block in the current block corresponding to a specific sub-block in the corresponding block, when a motion vector of the specific sub-block in the corresponding block is not available.
